(19) United States
(12) Patent Application Publication
(10) Pub. No.: US 2020/0389705 A1
(43) Pub. Date: Dec. 10, 2020

(54) MANAGING CONTENT USING IMPLICIT WEIGHTED RATINGS

(71) Applicants: Demetre Harris, Tucson, AZ (US); Julio Almeida, Tucson, AZ (US)

(72) Inventors: Demetre Harris, Tucson, AZ (US); Julio Almeida, Tucson, AZ (US)

(21) Appl. No.: 16/607,330

(22) PCT Filed: Apr. 23, 2018
(86) PCT No.: PCT/US2018/028933

§ 371 Date: Oct. 22, 2019

Related U.S. Application Data
(60) Provisional application No. 62/489,220, filed on Apr. 24, 2017.

(51) Int. Cl. H04N 21/475; H04N 21/45

(52) U.S. Cl. CPC H04N 21/4756; H04N 21/4532

(57) ABSTRACT

The present application is directed to determining content ratings based on content consumption. A first example implementation comprises examining consumption patterns of multiple consumers to determine the approval rating of the presented media content. The criteria examined may include whether the media was advanced or fully consumed, time or stage of the advancement, whether the media was repeated after full consumption, category preferences, and historical consumer consumption actions. A second example implementation comprises examining the consumption patterns of a single consumer to determine the consumer's approval rating of his/her personal media collection. The criteria examined may include whether the media content was advanced or fully consumed, time or stage of the advancement, whether the media was repeated after full consumption, whether the media was manually selected, and how much content was consumed before the rated content is consumed over a specified period of time.

### TECHNICAL FIELD

The present disclosure relates to computer systems, and more particularly, to a system for managing media based on ratings collected implicitly and weighted based on user characteristics.

### BACKGROUND

The entertainment business today is composed of many risks, hunches, trials and errors. New creators of media (such as authors of textual works, musical artists, video and/or graphical artists, etc.) may attempt to become mainstream entertainers by, for example, performing at local establishments to promote their music. These creators generate sales with the primary hope of catching their big break and getting signed to a recording label. The Bureau of Labor Statistics predicts that the employment of musicians and singers is projected to grow three percent from 2014 to 2024, but there may be tough competition for the jobs because of the large number of people interested in becoming musicians and singers. With over seven years of historical data, NextBigSound.com states in “The Taxonomy of Artists” report that “roughly 50% of artists fall below the mean and can be considered Undiscovered.” For the other 50% of creators who do continue performing either on a local or mainstream level, it's often a struggle to consistently stay ahead of the curve and provide media (audio and/or visual) well accepted by consumers. Often the success of new album releases is heavily dependent on the promoters of the media, the creators going on tours, the amount of consumers that get exposed to the content, etc. Promoters (including large record labels) may target key cities to gauge the success of newly release media.

In view of the large pools of candidates performing in various entertainment categories, Artists and Repertoire (A&R) departments of many record labels may experience great difficulty in quickly identifying top creators (i.e., “talent”). For example, major record labels may employ a large network of publishers, publishing companies, etc. to promote up and coming talent that they have recently uncovered. To identify this talent, record label executives may spend countless hours consuming media content to determine whether to invest in a particular creator. The process of choosing the next super talent may be very stressful and difficult. It is very difficult to know how a new creator may be received nationally and nearly impossible to predict such a performer's global reception. Therefore, many investments (e.g., creator signings) may be made based on limited information.

In view of the challenge involved in finding marketable talent, currently there is not an expedient solution by which the creator and record label may quickly and accurately determine if media content, such as a song and/or video, may appeal to consumers. Existing techniques to identify talent may comprise, for example, a process of trial and error that relies upon analyzing the reaction of small groups of consumers (e.g., a focus group). However, generating accurate data from a focus group may be difficult. The data may inaccurate if the focus group comprises unwilling or unfocused participants that may be providing ratings data for ulterior motives (e.g., to receive compensation, a prize or another benefit), participants that may be unfamiliar with the media content and/or the category into which the media content is classified (e.g., a focus group pertaining to country music wherein participants are more familiar with other musical genres such as rock, rap, etc.), participants that do not understand the importance of the rating they are submitting, etc.

### BRIEF DESCRIPTION OF THE DRAWINGS

Features and advantages of various embodiments of the claimed subject matter may become apparent as the following Detailed Description proceeds, and upon reference to the Drawings, wherein like numerals designate like parts, and in which:

FIG. 1 illustrates an overview of an exemplary system implementation that may utilize multiple computing devices configured to communicate over a wireless network.

FIG. 2 illustrates a table including an exemplary association of a consumer's media category preference to a consumer category preference weight.

FIG. 3 illustrates a flowchart of exemplary operations to identify options available to a consumer at an initial phase of calculating a media content rating.

FIG. 4 illustrates a flowchart of exemplary operations that may be executed if a consumer chooses to consume in its entirety media content presented in an initial phase.

FIG. 5 illustrates a flowchart of exemplary operations that may be executed if a consumer chooses to advance media content prior to completion in an initial phase.

FIG. 6 illustrates a flowchart of exemplary operations that may be executed if a consumer chooses to quit the media approval rating system without fully consuming media content.

FIG. 7 illustrates a flowchart of exemplary operations that may be executed if a consumer chooses to pause media content during consumption.

FIG. 8 illustrates a chart indicating an exemplary approval percentage given by the system to media content 5 minutes in length prior to factoring in a consumer's consumption behavior.

FIG. 9 illustrates is a chart indicating an exemplary bonus percentage accumulated by media content based on repetitions of content playback by a consumer after initial consumption.

FIG. 10 illustrates an exemplary single device implementation of a media approval rating system.

FIG. 11 illustrates a chart indicating exemplary media consumption statistics generated by a single consumer media approval rating system.

FIG. 12 illustrates a flowchart of exemplary operations for identifying the options available to a consumer consuming media content from his/her personal collection.

FIG. 13 illustrates a flowchart of exemplary operations for identifying the options available to a consumer at an initial phase of calculating the approval rating of an exemplary media content for a single consumer who chooses to let the system automatically select media content.

FIG. 14 illustrates a flowchart of exemplary operations that may be executed if a consumer chooses to consume in its entirety media content presented in an initial phase in a single consumer implementation.

FIG. 15 illustrates a flowchart of exemplary operations that may be executed if a consumer chooses to advance media content prior to completion presented in an initial phase in the single consumer implementation.

FIG. 16 illustrates a flowchart of exemplary operations that may be executed if a consumer chooses to quit the media approval rating system without fully consuming media content in a single consumer implementation.

FIG. 17 illustrates a flowchart of exemplary operations that may be executed if a consumer chooses to pause media content during consumption in a single consumer implementation.

FIG. 18 illustrates a flowchart comprising exemplary operations for defining the approval rating calculation for a single consumer implementation.

FIG. 19 illustrates a table including exemplary equalizer ranges and percentages assignable to media content based on the presentation frequency of media content over a specified duration.

FIG. 20 illustrates a block diagram of an exemplary computing device with which various embodiments may operate.

FIG. 21 illustrates an overview of an exemplary system implementation that may utilize multiple computing devices configured to communicate over one or more computer networks.

Although the following Detailed Description may proceed with reference being made to illustrative embodiments, many alternatives, modifications and variations thereof may be apparent to those skilled in the art.

### DETAILED DESCRIPTION

In at least one example embodiment, there is provided a computer-implemented system for providing media content (e.g., computer-readable data that may hereafter be referred to as “media content,” “media” or “content”) to be presented (e.g., to generate an output based on the content such as the generation of sound from audio data and/or visual images from video data) to a consumer (e.g., generally a person using the content rating system) to determine a rating (e.g., a media content approval rating) for the content. The content may initially be stored in a content library (e.g., database of content) with an approval rating of 100% on at least one storage medium. The content may be selected by a consumer from the content library randomly, based on the consumer's preferred categories configuration, in sequence based on a predetermined content list (such as a musical “playlist” or other listing of media content), manually based on consumer selection, based on a combination of one or more of these and/or other criteria, and/or in some other manner. Once the consumer is presented with the selected content for consumption, the consumer may have the choice to consume the content in its entirety, advance the content to the next selection within the content library (e.g., skipping the content during playback), pause the consumption of the content until further notice, or quit the consumption of the content through the computer-implemented system. The media approval rating of the content may be adjusted based on, for example, the consumer's actions during consumption, the time during consumption when activity occurs (e.g., if content advancement occurs), consumption behaviors of the consumer, etc. If the consumer chooses to consume the media content in its entirety, the consumer may be presented the option to repeat the media content. Repeating the content may have a positive effect on the media content's approval rating, but the effect may be limited with multiple repetitions by the same consumer. Advancing or quitting the consumption of the selected content may have an adverse effect on the media content's approval rating. The approval rating of a single consumer may be utilized to perform actions such as, for example, generating content lists, sorting/ranking content or removing undesired media content (e.g., deleting content from the database). The approval rating of multiple consumers may be utilized to gather an overall approval rating for content across a sample group of consumers. Different methods for calculating approval ratings based on time durations may be employed for consumers who choose to select media content manually. In this instance, the content approval rating may be negatively affected if the consumer does not select to consume the media during a specified period of time (e.g., day, week-to-date, month-to-date, year-to-date, first week of the month, month, year, etc.). For instance, where the consumer manually selects media content, media content may have a period specific approval rating. For consumers who access the system offline for a limited period of time, all ratings may remain locally in a device for the maximum duration (e.g., 24 hours) and may then be synced whenever the system is online again during this period. After this period, all consumer activity data stored on the local device may not be provided to the system (e.g., essentially discarding the data from the system).

In at least one other embodiment, there is provided a system configured to select content to be presented to a consumer and gather the consumer's approval rating for the selected content. Computer processor-executable instructions on at least one storage medium may be executed to cause content to be stored in a content library (e.g., database). The content may initially be stored with an approval rating of 100%. In various embodiments, content may be selected from the content library randomly based on the consumer's preferred content categories, in sequence based on a predetermined content list, manually based on consumer selection, etc. Along with the presentation of the selected content, the consumer may also be presented with a user interface (UI) including choices for controlling content playback. Example choices may include to consume the content in its entirety, advance the content to the next selection within the content library (e.g., skip the currently-selected content), pause the consumption of the content or discontinue the use of the content selection system. The user's interaction with the presented UI may generate one or more inputs or parameters usable for the system to adjust a rating of the content. For example, the consumption behaviors of the consumer including the consumer's consumption choices (e.g., to view the content in entirety, to advance prior to completion of the content presentation, to abort operation of the content playback system, or combinations of these activities or other activities), the time at which the consumer made their consumption choices (e.g., if content advancement is chosen), etc. may be employed by the system to adjust a media approval rating for the content. If the consumer chooses to consume the media content in its entirety, the consumer may also be presented an option to repeat the content. In at least one embodiment, repeating the content may have a positive effect on the content's approval rating. However, the beneficial effect of each repeat by the same consumer may be limited (e.g., may be ramped or stepped down). Advancing or quitting the consumption of the selected media content may have an adverse effect on the media content's approval rating.

The approval rating of content generated by a single consumer may be utilized to perform actions such as generating content lists, sorting media content, or removing undesired media content from the system (e.g., to help manage memory consumption within the system). In the same or a different embodiment, the approval rating of multiple consumers may be utilized to generate an overall approval rating for content across a sample group of consumers. The manner in which approval ratings are generated may vary for consumers that select media content manually, at least with respect to how time duration is considered in the calculation. For example, the media content approval rating may be negatively affected if the consumer does not select to consume the media during a specific duration (e.g., same day, week-to-date, month-to-date, year-to-date, first week of a month, a month, etc.). Ratings for content may be generated over different time periods (e.g., week-to-date, month-to-date, year-to-date, monthly, etc.). In the same or a different embodiment, consumers may periodically or sporadically operate the system in an offline mode (e.g., wherein a consumer downloads content to a local device for offline consumption), ratings may remain in the local device for a maximum period of time (e.g., 24 hours). During this period, captured user behavior data may be synced with the system when the local device is again online. After this period, behavior data stored on a local device may not be synchronized with the system, and thus this information may not be considered in generating content ratings.

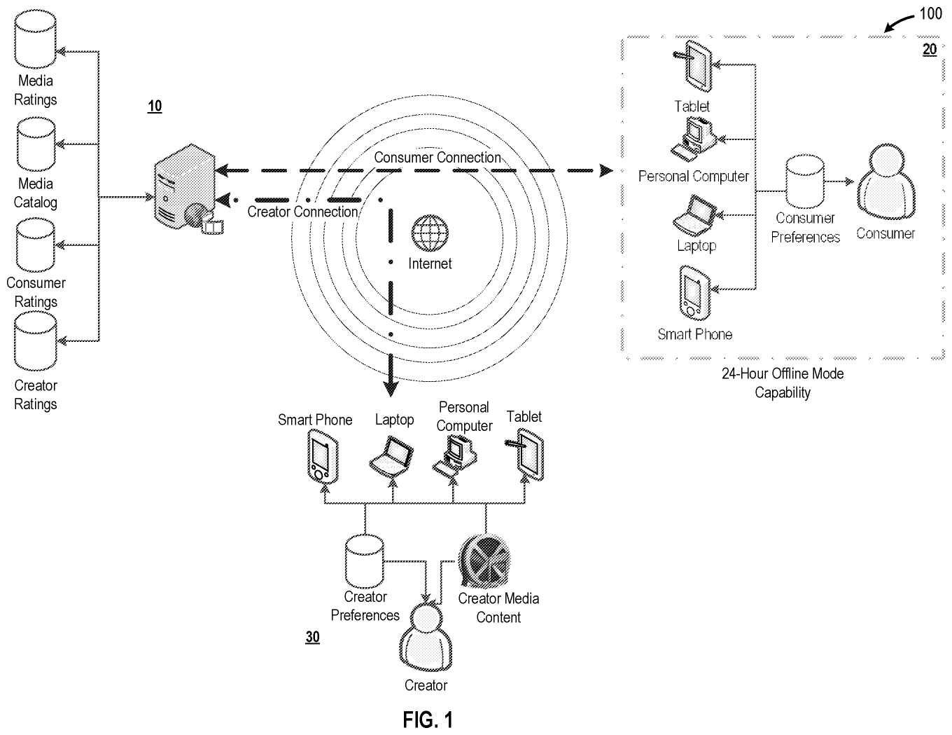

FIG. 1 illustrates an overview of an example system implementation that may utilize multiple computing devices configured to communicate over a wireless network. Example system 100 disclosed in FIG. 1 comprises at least three zones: a ratings system zone 10, a consumer zone 20 and a creator zone 30. Zones 10, 20 and 30 may interact over a network such as a global area network (GAN), a wide-area network (WAN) like the Internet, a local-area network, etc. Ratings system zone 10 may comprise at least one computing device (e.g., a server computer). In one example implementation, one or more servers may be organized in a cloud computing architecture. These servers may be configured to work collaboratively to service incoming requests received via the Internet from consumer zone 20 and creator zone 30. The servers may be able to interact with one or more of databases associated with the ratings system. Example databases that may reside in ratings system zone 10 may comprise, but are not limited to, a media ratings database, a media catalog database, a consumer ratings database and a creator rankings database as shown in FIG. 1. Examples of the purpose and uses of these databases will be discussed further regarding the operation of the ratings system.

Consumer zone 20 may comprise various devices owned, or at least used by, consumers for accessing ratings system zone 10. For example, the consumer may configure various devices such as, but not limited to, tablet computers, desktop computers, laptop computers, smart phones, etc. to access ratings system zone 10 via a consumer connection. The consumer may further store preferences for use in interacting with ratings system zone 10. The consumer preferences may be stored, in whole or in part, in a consumer device in consumer zone 20, in a database in the ratings system zone 10 or in a combination of the two. Ratings system zone 10 may utilize the consumer preferences to automatically select and present content to the consumer, or the consumer may manually select content. The presentation of content may comprise, for example, generating sound during playback of a song, generating sound and video to playback a music video, television show, movie, etc. Content may be available to the consumer online or offline. Online may comprise consuming content as it is provided (e.g., streaming) from a database in ratings system zone 10. Offline may comprise downloading content for consumption on a consumer device when offline (e.g., not coupled to ratings system zone 10 via the Internet).

Creator zone 30 may comprise at least one device associated with a creator (e.g., musician, television or movie producer, etc.) that may be coupled to ratings system zone 10 via a creator connection. A variety of devices like those disclosed regarding consumer zone 20 are presented as an example. In at least one embodiment, creators may maintain a database of original content. The creators may employ one or more devices to communicate over the creator connection to upload content from their content database to ratings system zone 10, to retrieve content ratings from ratings system zone 10 for content that was previously uploaded, etc. In this manner, creators may be able to utilize ratings system zone 10 to get their original content in front of consumers. The actions of the consumers may be monitored by ratings system zone 10 to determine both content ratings and consumer ratings. The content ratings may then be fed back to interested parties (e.g., the creators that created the original content, agents, producers, etc.) for judging the quality of the content, the characteristics of the consumers, the abilities of the creator, etc.

Conventional techniques for rating content may rely on an explicit (e.g., system-solicited) consumer rating such as, for example, the consumer assigning a rating to the content (e.g., rating the content on a scale of one through five), indicating a thumbs-up or thumbs-down for approval or disapproval, respectively, etc. This type of system causes a consumer to abandon their usual process of consuming media through playing, pausing, advancing, and/or repeating content to take the time to rate the content that was just consumed. In view of the manual interaction necessary to rate media content, only a small number of consumers give ratings in this system. The small amount of feedback from a manually-driven system may lead to content ratings that are questionably accurate. For example, the consumers that explicitly rate content may be motivated to do so by overly strong feelings, yielding wildly fluctuating ratings data. Typical consumers may not be overly satisfied or totally disgusted with the content, but their ratings may go unknown since they are not motivated to provide manual feedback to the system. Moreover, the conventional explicit rating method of providing one to five stars may vary subjectively from consumer to consumer. For example, a first consumer may rate content as five stars without actually consuming the content based only on an indication of the creator associated with such content, while consumer B may rate the same content with another rating based on their enjoyment while consuming the content in its entirety. This unavoidable subjectivity in explicit ratings systems results in inconsistent and unreliable ratings.

Conventional techniques for rating content also do not allow a consumer to input ratings while involved in other activities. Consuming content is important in the daily routines of most consumers, and often takes place while the consumer is engaged in another activity such as, for example, driving automobiles, exercising, doing chores, studying, etc. Consumers may not risk an unsafe situation to provide content ratings, and likewise may not take the time to pause from their current activity to rate media content. The instances wherein a consumer does not manually input ratings result in missed opportunities to obtain the most accurate ratings data. This ratings data could be used to enhance device operation through, for example, the ability to automatically formulate content lists utilizing ratings generated by the consumer's consumption history, behaviors, etc. In existing systems, the content lists and media ratings on media devices are often manually selected by the consumer.

There are typically five activities that may be available to a consumer in any playback system. Content may be consumed in its entirety, paused, advanced, repeated, or stopped. Consumers who consume the content in its entirety and/or repeats the content may have a high approval rating of the media content. Consumers who advance or stop media content prior to consuming the media in its entirety may have a medium to low approval rating of the media content at the time of consumption. Various embodiments consistent with the present disclosure may utilize consumer characteristics, at least these five activities, the time that the activities occurred and other measurable behavior of the consumer to generate content ratings.

In at least one embodiment, a system is disclosed for generating ratings for content over a networked media streaming system comprising multiple content consumers. When generating content ratings by analyzing the actions of multiple consumers, rules, restrictions, etc. may be enforced to avoid introducing strong bias from certain consumers or consumer groups. Content to be presented to a consumer in a networked content streaming system may be automated in a way to personalize each consumer's content presentation experience. For example, consumers may be allowed to store content category preferences. Consumers with content category preferences may have the option to either allow the system to present content randomly from the list of preferred categories or select a category to be used by the system. Consumers without content category preferences may only have the option to select a category to be utilized by the system. Initial content presented to the consumer may comprise content with high approval ratings to better engage the consumer with consuming content on the system. Future content presentation may include relevant content with little or no rating history (e.g., new content) to help with the maturation of content's rating.

The calculation of media approval ratings for content in systems with multiple consumers may rely heavily on how a consumer consumes the media. The characteristics of the consumer may also be important for the accuracy of the system. These characteristics may include, for example, user demographics, user content preferences, user participation level, etc. Due to the need to gauge the behavior of the consumer, a consumer behavior rating must be calculated to determine the weight of the consumer's actions on the overall approval rating of the content. Consumer behavior ratings may be calculated by analyzing the consumer's user status, content category preference and playback habits (e.g., advancing habits and quitting habits). Described below are exemplary techniques and implementations of gathering the consumer's user rating to be used when gathering a consumer's approval rating for media content.

Consumer's user status (CUS) may be gathered by analyzing the usage of the consumer. An example implementation consistent with the various embodiments of the present disclosure may comprise three user statuses: Executive, Premium, and Standard. In at least one example implementation, executive status may be granted to consumers who pay for access. Executive status users may have access to content and statistics unavailable to other users. The ratings generated by executive status consumer activity may be weighted more heavily than the other consumer statuses. For example, the ratings generated by executive status consumers may be assigned a weight of 1.10. Executive status may be lost if a consumer stops paying for access.

Premium status may be granted to consumers who access the system consistently (e.g., daily) over a certain period of time (e.g., for at least seven consecutive days). Ratings generated based on the activities performed by premium status consumers may be weighted less than the ratings generated by executive status consumers, but above the ratings generated by standard consumers. For example, the ratings generated by the activity of premium status users may be assigned a weight of 1.05. Premium status may be lost based on a condition such as the consumer stopping normal participating in the rating system (e.g., misses one day of logging in after seven consecutive days of logging into the system). Standard status may be granted to any consumer logging into the system who does not meet requirements of the executive or premium statuses. For example, the ratings generated by standard status consumers may carry a weight of 1.00. The above ratings are based on the expectation that consumers who pay for access may be more engaged in the system. Therefore, consumers that pay should wield more substantial influence in driving content rating, which may also serve as a motivator to cause consumers to subscribe. Premium consumers that consistently participate (e.g., that log in for at least seven consecutive days) also demonstrate substantial commitment that may merit increased weighting.

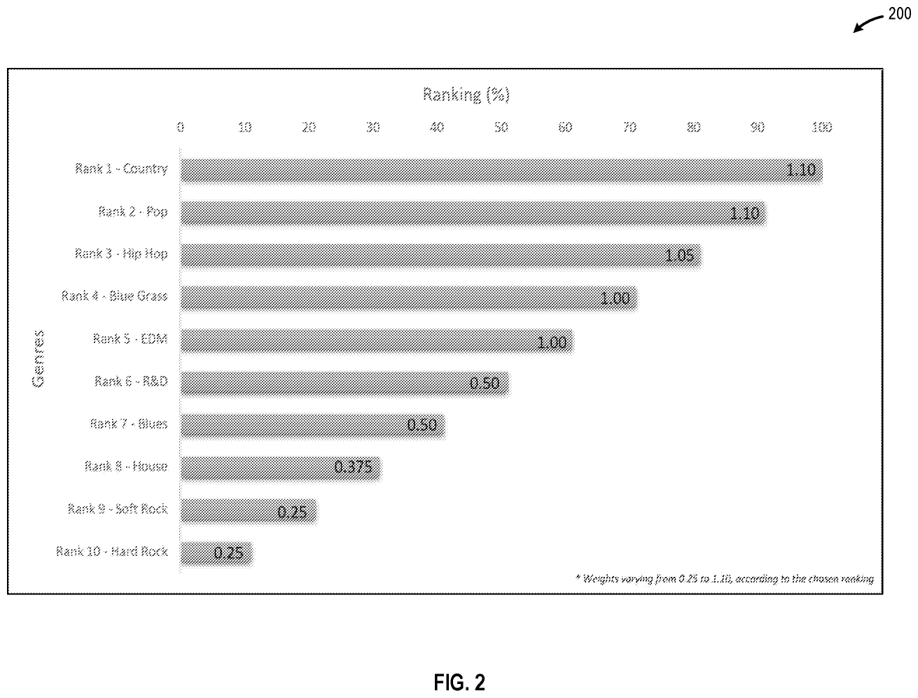

In at least one embodiment, consumer content category preferences (CCCPs) may be assessed during consumer registration with the system. For example, a consumer may be given an option to rank the available media categories for various content. For example, when the content is music, consumers may select their favorite categories such as rock, rap, country, folk, alternative, classical, etc. A list of the available media categories may be compiled based on content available in the system. New categories may be added to the available media category list as new content for the category becomes available in the system. A new category being added may cause the system to prompt the consumer to review his/her consumer preferences and category rankings. Following are example weights (for use in determining content rating) that may be assigned based on a consumer's category ranking. Consumer activity may carry a weight of 1.10 for activities performed against media that is included in the top twenty percent (81% to 100%) of categories ranked by the consumer. Consumer activity may carry a weight of 1.05 for activities performed against media that is included in the next ten percent (71% to 80%) of categories ranked by the consumer. Consumer activity may carry a weight of 1.00 for activities performed against media in the following twenty percent (51% to 70%) of categories ranked by the consumer. Consumer activity may carry a weight of 0.5 for categories in the next to the lowest twenty-five percent (26% to 50%) of categories ranked by the consumer. Consumer activity may carry a weight of 0.25 for categories in the lowest twenty-five percent (1% to 25%) of categories ranked by the consumer. An example of consumer rating weights based on the consumer's media category preferences ranking consisting of ten categories may be found in FIG. 2. The media approval rating system may contain main categories and expectations are that ratings of media content should be more driven by consumers who are fans of the category instead of consumers who may not understand the material.

As previously discussed, consumer advancing habits may affect rating generation for content. Advancing habits may include how content is consumed and may include, for example, whether a user consumes content in entirety, pauses the content, skips the content before playback of the content is complete, etc. Content is advanced when the consumer interacts with a user interface to cause the current content to be skipped (e.g., to load new content). Consumption habits for consumers may vary from day to day. Thus, consumer advancing habits must be assessed as consumer advancing daily habits (CADH) and consumer advancing all-time habits (CAAH) weight for each category. Initial content presented to the consumer may comprise content with high approval ratings. A daily advancement rating which may comprise a rolling average of content advanced versus content played may be stored and reset each day. A weight of 1.00 may be given if the consumer's daily advancement rating is less than or equal to fifty percent (e.g., if a consumer consumes at least 50% of the presented content). A weight of 0.5 may be given if the consumer's daily advancement rating is above fifty percent. At least one rationale for this type of weighting is to ensure that media content is not incorrectly rated based on the habits of some consumers. In addition, in the instance of music/video the content consumption may be activity specific. Consumers who consume media content while exercising typically consume high pace content. During this time, the consumer may advance any content that does not meet the standards necessary for the workout. These behaviors, regardless of their source, must be assessed and manage so that the media content is rated according to the quality of the content and not the activity of the consumer.

A consumer's all-time advancing habits within each category may be also considered and analyzed when determining a content rating. For example, a weight of 1.0 may be given to consumers with an all-time advancement rating less than or equal to fifty percent. A weight of 0.25 may be given to consumers with an all-time advancement rating above fifty percent. Assigning a weighting for all-time advancing habits' may help to protect content rating from consumers who habitually advance content (e.g., to sample various content). Looking at the combined effect of the daily and all-time advancing weightings, daily advancing habit weighting may help to limit the effect of consumers who may advance during specific activities throughout the day, while all-time advancing habit weighting may help to limit the effect of consumers who regularly skip through content regardless activity they are performing while consuming content.

Another characteristic that may be utilized to determine a consumer behavioral rating is the consumer's quitting habit (CQH). Quitting, as referenced herein, may comprise a consumer disorderly quitting the ratings system. Examples of disorderly quits may comprise shutting down a ratings system user interface application during content presentation (e.g., playback) without first requesting an orderly shutdown (e.g., logging out), turning off a device on which the ratings system user interface application is executing, etc. For example, a consumer that quits during content presentation less than or equal to fifty percent of the time may be given a weight of 1.0. Consumers who quit during media presentations greater than fifty percent of the time may receive a weight of 0.5. Weighting a consumer's quitting habit weight helps to ensure that all creators' media content is treated equally. Without adding the quitting habit weight, a consumer would be able to unjustly quit media content to avoid giving the media content a negative rating.

Consistent with the present disclosure, the consumer behavioral weights described above may be compiled into an overall consumer behavioral weight. The overall consumer behavioral weight is one component that may be used to calculate the media approval rating for the selected media content. Given the minimum values of the above weights that were provided as examples, the lowest possible value for the overall consumer behavioral weight may be:

CUS(1)*CCCP(0.25)*CADH(0.5)*CAAH(0.25)*CQH(0.5) (Eq. 1)

resulting in a consumer behavioral weight of 0.015625. In Eq. 1, CUS may correspond to Consumer User Status, CCCP may correspond to Consumer Content Category Preferences, CADH may correspond to Consumer Advancing Daily Habits, CAAH may correspond to Consumer Advancing All-time Habits, and CQH may correspond to the Consumer Quitting Habit. Based off the maximum values of the above example weights, the highest possible value for the overall consumer behavioral weight would be:

CUS(1.1)*CCCP(1.1)*CADH(1)*CAAH(1)*CQH(1) (Eq. 2)

resulting in an overall consumer behavioral weight of 1.21. After determining the consumer's behavioral rating weight, content consumed by the consumer may then be rated to formulate the content's approval rating. Following are example techniques for calculating the approval rating percentage of content consistent with the various embodiments of the present disclosure.

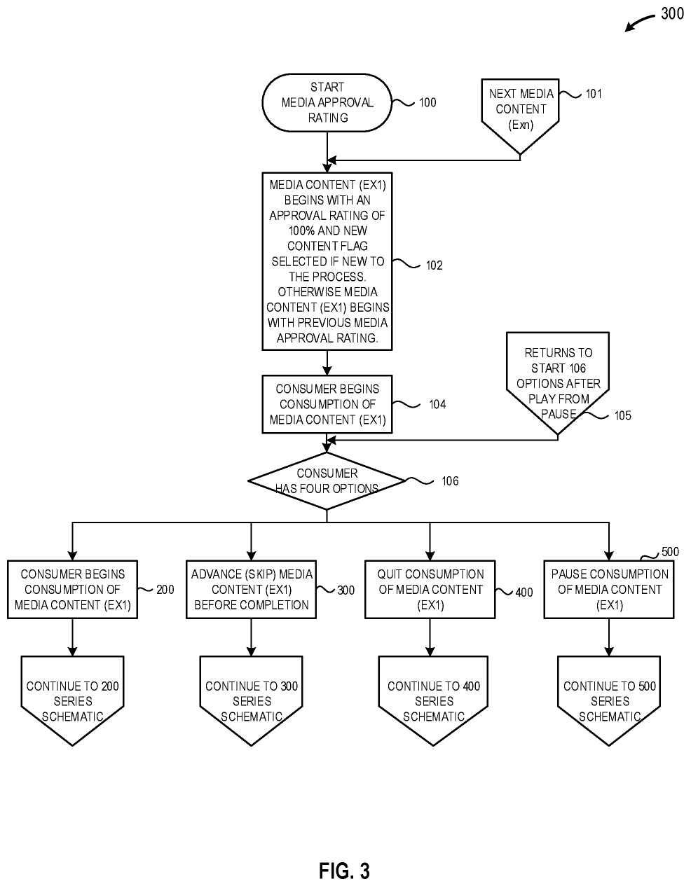

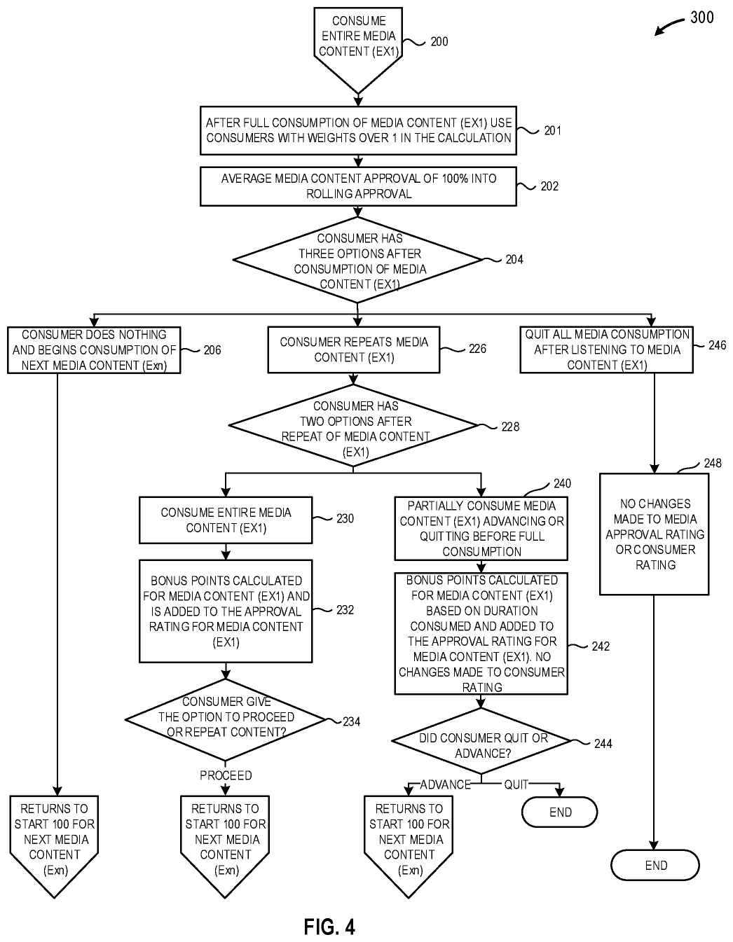

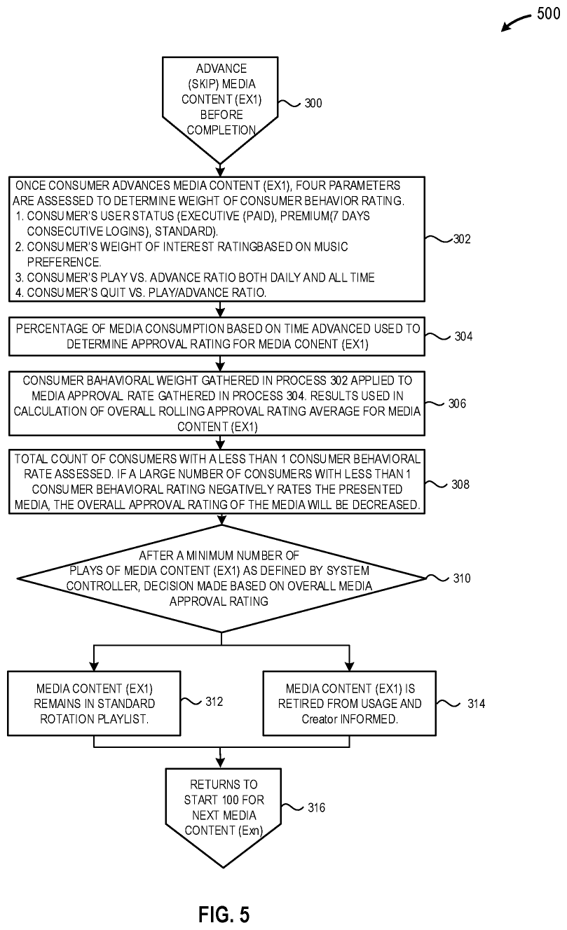

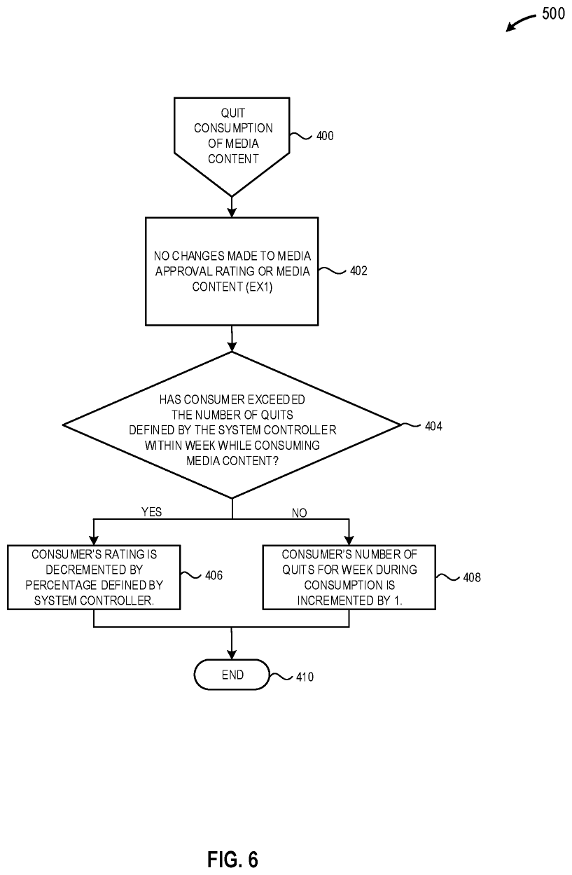

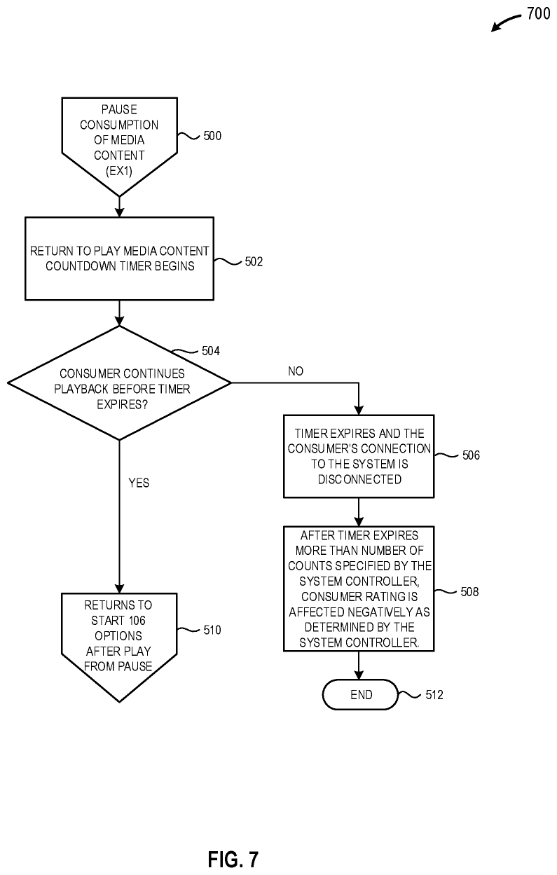

FIG. 3 illustrates a flowchart of example operations to identify options available to a consumer at the initial phase of calculating a rating for content. Flowchart 300 initiates at operation 100 with a randomly selected media content of a selected category being presented to the consumer for consumption. To ensure user engagement, the system may present highly rated content first to foster the consumer's appetite for consumption. In operation 102, the media content (EX1) enters the system with a rating from the media approval rating system. Media content that is new to the system may be assigned an approval rating of 100%. In at least one example implementation, new content may also comprise an indicator specifying that the content is new to the system. During consumption of the content, the consumer may have four options as depicted in operation 106. In operation 200 a consumer may initiate consumption of content with the possibility of completely consuming (e.g., full playback) of the content. An example of detailed operations that may be involved in operation 200 is illustrated in FIG. 4 and may include operations that are executed if the consumer consumes the media content in its entirety. A second option is presented in operation 300 wherein media content may be advanced before completion. An example of detailed operations that may be involved in operation 300 is illustrated in FIG. 5 and may present an example effect that advancing media content prior to consuming the content in its entirety has on a content rating. A third option wherein a consumer quits the consumption of content without fully consuming or advancing content is shown in operation 400. Operation 400 may focus on actions that may be executed if the consumer quits the media approval rating system during media content consumption. Operation 400 is described in greater detail in FIG. 6. A fourth option wherein a consumer pauses consumption of media content is illustrated as operation 500 in FIG. 3. Operation 500 is described in greater detail in FIG. 7. Operation 500 may take into consideration consumers who may need to pause content during consumption.

The following describes the above example operations in more detail and how each action of a consumer may be utilized in calculating ratings for presented content in a multiple consumer system. FIG. 4 illustrates a flowchart of example operations that may be executed if a consumer chooses to consume in its entirety media content presented in an initial phase. As indicated in operation 201, after full consumption of the presented media content, the first order of action may be to access the consumer behavioral weight of the consumer consuming the media content. A purpose of the consumer behavioral assessment may be to determine if the consumer has an overall consumer weight above 1.0. Consumer behavioral weights above 1.0 may indicate that the system should consider more heavily the consumer's rating of the content. Consumers having behavioral weights below 1.0 who consume the content in its entirety may have their behavioral weight adjusted to be 1.0 since the content was fully consumed. Fully consumed content may not be affected negatively based on consumers having low behavioral ratings since the content was fully consumed.

After the consumer behavioral weight is accessed, the weight may then be multiplied by a media consumption rating of one hundred percent (100%) and averaged into the rolling overall approval rating for the presented media. In at least one embodiment, content may be deemed fully consumed, and thus may be assigned a 100% consumption rating, when at least seventy-five percent (75%) of the content is consumed by the consumer. Full consumption may exist at seventy-five percent (75%) so that content ratings are not affected by white space, credits, or monologue that sometimes occurs at the end of media content. In the example implementation that is illustrated in FIG. 4, after fully consuming the presented media content, the consumer may perform one of three actions. The consumer may do nothing and begin consumption of the next content as illustrated in operation 206, repeat the previously presented content as illustrated in operation 226 or may quit all media consumption as illustrated in operation 246. Operation 206 indicates the consumer's action is to do nothing and begin the consumption of the next media content. In this case, the next media content of the selected category is loaded by the system and the system returns to FIG. 3, operation 101. Proceeding to the next content may be considered default behavior for the media approval rating system at this point, and if the consumer chooses not to interact with the system (e.g., to select content, exit the system, etc.), the next content may be loaded and consumption may begin soon after the previous content is consumed in its entirety.

A consumer's decision to repeat the selected media content is illustrated in operation 226. To maintain the integrity of the media approval rating system, after the first repeat (e.g., replay of the content) all subsequent repeats by the same consumer may have a lesser effect on the overall approval rating for the repeated content. Allowing each repeat to have the same effect on the approval rating allows a consumer to introduce an unfair bias into the system and may skew the approval rating for the selected content. In the example implementation depicted in FIG. 4, after selecting the option to repeat the content, the consumer then has two options illustrated as operations 230 and 240. The consumer can choose to either consume the entire content again as shown in operation 230, or may choose to advance or quit the content prior to full consumption as shown in operation 240. In at least one embodiment, consumers who choose to consume the repeated content per operation 230 may accumulate a bonus (e.g., 5%) for the content consumed in operation 232. The bonus percentage may be added to the consumer media approval rating of the consumed content. After the media approval rating is incremented by the bonus (e.g., 5%), the consumer may have the option in operation 234 to repeat the content again or return the system to FIG. 3, operation 101 to consume additional content. A decision to repeat the content again may return the consumer to operation 228. Subsequent repeats may not have the same effect on the overall media content approval rating as the initial request to repeat the content. The following formula may be used to determine the bonus percentage for subsequent repeats:

BP=5/(NR2) (Eq. 3)

where BP corresponds to the Bonus Percentage and NR corresponds to the number of repeats. A graph 900 entitled “Bonus Percentage Accumulated Based on Number of Repeats” is shown in FIG. 9. Graph 900 demonstrates a possible effect of the bonus percentage formula in Eq. 3.

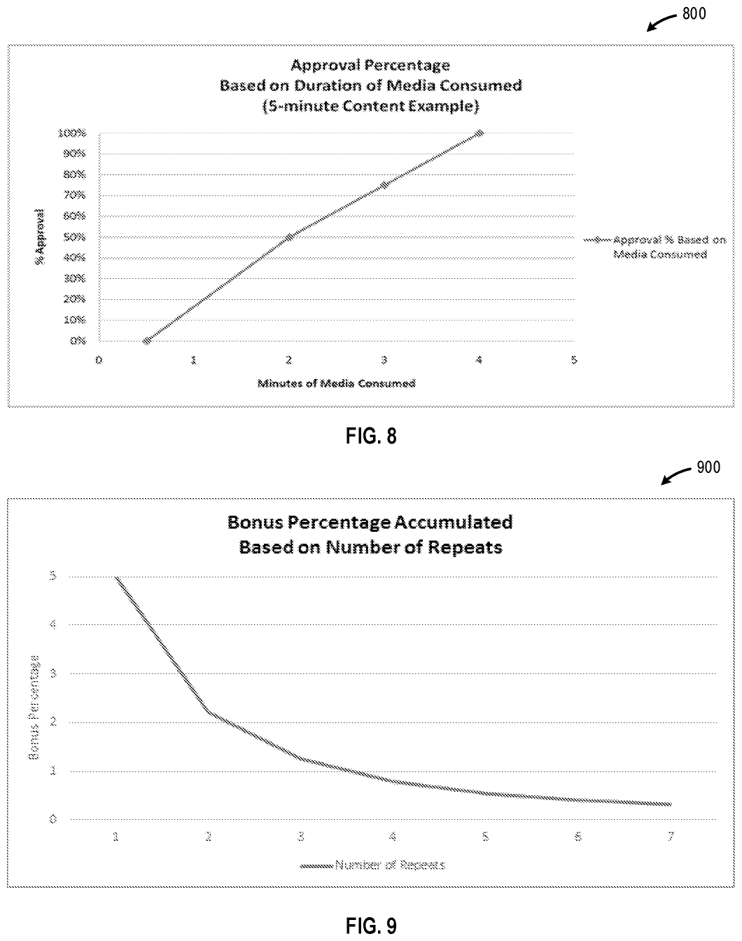

Consumers who choose to partially consume repeated content in operation 240 (e.g., by either advancing or quitting content consumption before the content is fully presented) may still accumulate bonus points for the repeated media content as shown in operation 242. However, in this instance the bonus points accumulated may be derived from the amount (e.g., duration) of content consumed. An example graph 800 depicting an approval percentage based on duration of media consumed is shown in FIG. 8. A determination may then be made as to whether the consumer advanced or quit in operation 244. The premature advancement or quitting of repeated media content may not affect the media consumption rating or the consumer behavioral rating for that consumer. Consumers who advance the repeated media content before full consumption may return to operation 101 in FIG. 3 to consume more content. In at least one embodiment, a consumer who quits before full consumption of repeated media content may be exited from the system (e.g. END in FIG. 4). Being “exited” from the rating system may comprise, for example, the rating system automatically executing an orderly deactivation of one or more user interfaces associated with the rating system, deactivation of certain functionality in the rating system or deactivation of the rating system in entirety (e.g., at least the portion specific to the consumer).

Another action available to consumers who consume the presented media content in its entirety would be to quit all media consumption as shown 246. Quitting the application after full consumption of the presented media content may not affect the media approval rating for the previously consumed media content nor the next media content to be presented as shown in operation 248. In addition to the media approval rating not being affected, the consumer behavioral rating would not be affected; because quitting between media presentations is considered a clean exit from the system. The consumer may then be exited the consumer from the system (e.g., END in FIG. 4).

FIG. 5 illustrates a flowchart of example operations that may be executed if a consumer chooses to advance media content prior to completion in an initial phase. Flowchart 500 details logic that may execute if a consumer decides to advance (skip) the selected media content before full consumption. Once the consumer advances the media content prior to full consumption in operation 300, the consumer behavioral weights may then be assessed to determine the overall weight of the consumer's advancement for the selected media that was recently advanced. As shown in operation 302, the consumer behavioral rating comprises a calculation that may take into consideration: 1. Consumer's user status (executive, premium, standard), 2. Consumer's weight of interest based on the consumer's preferred music preference, 3. Consumer's play vs. advance ratio for the day and all-time and 4. Consumer's quit vs. play/advance ratio.

After the consumer behavioral rating is calculated in operation 302, in operation 304 the approval percentage is calculated using a Polynomial equation

CAP=0.43(DMC³)−0.96(DMC²)+1.69(DMC)−0.16 (Eq. 4)

wherein CAP corresponds to a Consumer Approval Percentage and DMC corresponds to a Duration of Media Consumed. Graph 800 in FIG. 8 visually demonstrates this relationship. In at least one embodiment, the ratings of content advanced before the consumer consumes the first 10% of the media content may be discarded and may not affect the overall approval rating for the media content. As previously discussed regarding FIG. 4, operation 200, content may be deemed fully consumed when 75% or more of the content is consumed and a rating of 100% or more may be applied.

In operation 306 the consumer behavioral weight is applied to the consumer's media content approval rating. In at least one embodiment, the calculation of the consumer's media content approval rating consists of two different formulas based on whether the consumer has a behavioral weight above or below 1.0. For consumers with behavioral rates greater than or equal to 1.0, the calculation is:

COBR*MCAR=CCAR (Eq. 5)

wherein COBR corresponds to the Consumer Overall Behavior Rate, MCAR corresponds to the Media Content Approval Rating and CCAR corresponds to the Consumer Content Approval Rating. Using the above calculation, consumers with behavioral rates greater than or equal to 1, ratings shall be taken as face value and have a greater effect on disapproval of media content. The effect of consumers with a behavioral rate less than 1.0 may be limited on the disapproval of media content. The calculation for obtaining gathering the consumer content approval rating for these consumers is

(COBR*MCAR)+(1−COBR)=CCAR (Eq. 6)

The above calculation may be used to minimize the effect of consumers who may not actually be a fan of the media content presented to them or who has a history of advancing or quitting presented content.

Operation 308 may address a situation wherein a certain number of consumers (e.g., a majority) consuming content having a media rating less than 1.0. If the activities of the majority of the consumers with low ratings causes a low rating to be generated for the content, the media content rating may not truly reflect the rating of the content. This issue may be addressed in various embodiments by counting the consumers having consumer behavioral ratings below 1.0 who negatively advance the content. If after a certain number of consumers (e.g., 100 total consumers) the count of the low rating consumers reaches fifty-one percent (51%) of the certain number of consumers, the overall approval rating of the content may be decreased by a 0.25. In this manner, an overwhelmingly consistent (negative) reaction to content may be considered even if the reaction occurs in a group of consumers with ratings lower than 1.0. This assessment may occur whenever content is consumed by the certain number of new consumers (e.g., 100), and the overall approval rating may be decreased by another quarter (0.25) if conditions are met.

In operation 310, media content that is consumed and rated a certain number of times (e.g., 100) by one a certain number of unique users (e.g., 100) may form a selected sample group, and the selected sample group may then be put to additional tests. For example, the overall approval rating of the content may be assessed. Based on this overall approval rating, a decision may be made as shown in operations 312 and 314. Operation 312 corresponds to logic wherein the overall approval rating is positive or the minimum number of unique consumptions by unique consumers is not met. If the rating is positive or the conditions are unmet, different outcomes may be generated. In the depicted example, the content may remain in the standard rotation content list and may continue to be presented or made available for selection to consumers. Operation 314 corresponds to the logic if the overall approval rating is negative. As with the positive overall rating, different outcomes may be executed. In depicted examples, the content may be retired from usage. Retirement may comprise, for example, the creator being notified and the content being removed from the system. After analysis is completed and actions executed in operations 312 or 314, the consumer is returned to FIG. 3, operation 101, for additional content.

FIG. 6 illustrates a flowchart of example operations that may be executed if a consumer chooses to quit the media approval rating system without fully consuming media content. FIG. 6 includes a flowchart 500 of example operations that may occur when consumers quit the system prior to fully consuming content and without advancing the content as shown in operation 400. Quitting the system at this point may be considered a “dirty” exit from the system. In operation 402, no changes are made to the media consumption rating for the selected media content. At least one rationale for not changing the rating due to a consumer quitting is because the reason for a consumer quitting could be related to various events such as system timeout, power loss, etc. Despite there being various cases of acceptable reasons for quitting the system, there may also be cases of unacceptable reasons for quitting such as manual powering off system to avoid applying a negative rating. Due to these outside cases, the number of consumer system quits may be measured and applied as one of the consumer's weights as discussed previously.

Operation 404 pertains to tracking dirty system quits and a comparison to see whether the number of quits within (e.g., within a certain period of time like a week) exceeds the number of allowed system quits for the period of time. Consumer system quits exceeding the number of allowed quits may cause a negative impact to the consumer's rating for number of quits as shown in operation 406. If the consumer has not exceeded the number of allowed quits, in operation 408 the number of quits for the consumer is incremented by one and stored (e.g., in a user ratings registry). Afterwards, the system may be exited as shown at 410.

FIG. 7 illustrates a flowchart of example operations that may be executed if a consumer chooses to pause media content during consumption. FIG. 7 includes flowchart 700 of example operations to address the situation wherein a consumer pauses consumption of content. Pausing content consumption is foreseeable, and the system must be able to handle pauses appropriately. Moreover, the media approval rating system is a system that may depend on tracking interactions from multiple consumers. The assessments generated in the system may be based off receiving consumer approval ratings in a timely fashion. Due to this fact, the following embodiment was considered. Once the pause action is executed by the consumer, a return to media consumption countdown timer starts as indicated in operation 502. The consumer may continue consumption before the timer expires in operation 504, wherein the consumer may be returned to FIG. 3, operation 105, to continue with consumption. If the return to media consumption countdown timer expires in operation 504, the consumer's connection to the system may be disconnected in operation 506, and the instance may be counted a dirty exit from the system. As with other unclean system quits, in operation 508 the consumer behavioral rating may be negatively affected if the consumer exceeds a specified number of allowed quits within a certain period of time (e.g., a week). The system may then be exited in operation 512.

Consistent with the present disclosure, another methodology may be utilized to determine media approval ratings for content in single consumer systems. Example system may be in the form of a personal media playing device, computer application, mobile device application, etc. Calculating the approval ratings of content in a single consumer system may be quite different from the calculations utilized in a multiple consumer system. Several consumer behaviors that were concerning when implementing a multi-consumer system are not as important in a single-consumer embodiment because the media approval rating system may be completely biased. Also, since the approval rating system does not rely on a network or input from multiple consumers, the tracking of attributes such as the number of quits and applying timeouts to how long the user pauses content does not apply to the single consumer system.

Just as consumer approval ratings for media in his/her personal collection may change throughout time, the single consumer media approval rating system may be capable of reflecting approval ratings based on specific time periods. In view of this enhancement, the system may be able to provide the following approval ratings of media content: daily, weekly, monthly, yearly, week-to-date, month-to-date, year-to-date and all-time. To provide approval ratings based on a duration, the approach for the calculation of the media approval rating may change. Instead of calculating the rolling approval rating average of media content, the consumption statistics may be stored in the system so that analysis may be performed based on the selected duration. For example, FIG. 11 illustrates a chart indicating example media consumption statistics generated by a single consumer media approval rating system. More specifically, chart 1100 in FIG. 11 provides an overview of an example selection of statistics that may be stored for future analysis.

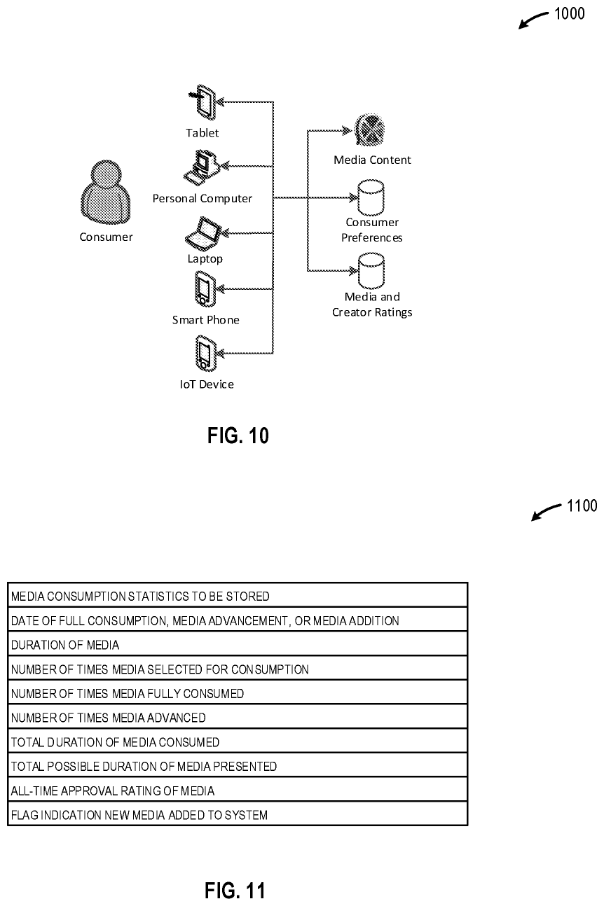

FIG. 10 illustrates an example single device implementation of a media approval rating system. Similar to FIG. 1, FIG. 10 shows an example system 1000 for a single device system. A consumer may be associated with at least one exemplary consumer device, with non-limiting examples including a tablet computer, a personal computer, a laptop computer, a smart phone, an IoT (“Internet of Things”) device, etc. In the system 100 of FIG. 1, various resources were arranged in different zones that each comprised their own computing resources. However, in system 1000 of FIG. 10, all resources may reside on a single device. Thus, the consumer device may comprise at least one database to store media content, consumer preferences, media and creator ratings, etc. In this manner, some or all of the functionality discussed regarding FIG. 1 may be concentrated on a single device. However, the concentration of these resource may require measures not required in the example of FIG. 1 such as more efficient use of resources, especially in a device such as a smartphone where resources like memory may be constrained. In at least one embodiment, content ratings generated by the activity of a consumer may be shared amongst various consumer devices. This sharing may be facilitated by, for example, a cloud-based service that tracks the ratings generated by the consumer interacting which each device and then combines the individual content ratings to generate an overall content rating. Operating as set forth above may avoid a situation wherein a consumer consumes content using different devices that each generate content ratings that may be different for the same content.

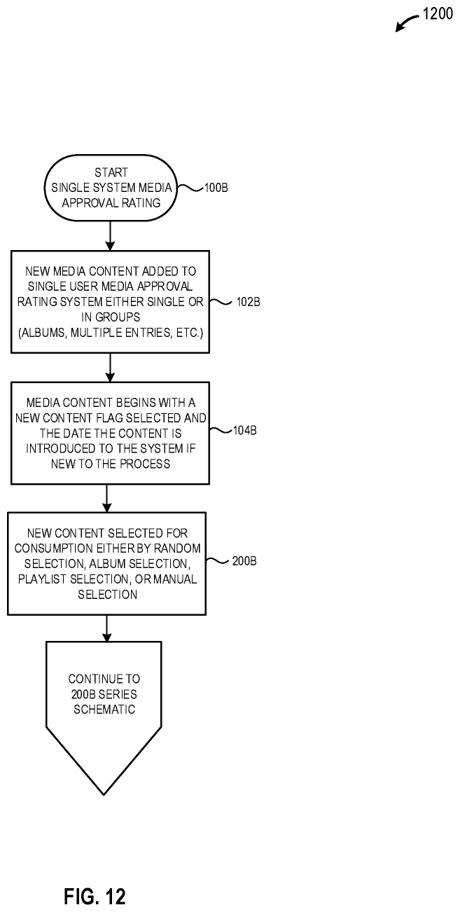

FIG. 12 illustrates a flowchart of example operations for identifying the options available to a consumer consuming media content from his/her personal collection. Flowchart 1200 in FIG. 12 shows a single consumer approval rating system that may rely mainly on a consumer introducing new media content into the system. New content may be added either as standalone compositions or collections of content in operation 102B. In at least one embodiment, new content added to a consumer's personal collection may also be stored in the system with a new media flag entry indicating that the content is new to the system in operation 104B. Unlike a multiple consumer approval rating system, a single consumer approval rating system may not automate content presentation to the consumer based on a specified category. Instead, a consumer chooses how to consume the media such as shown in operation 200B. The consumer may select content to be consumed by, for example, random selection, album selection, content lists, manual selection (e.g., via a user interface), etc. An important objective of the single consumer media approval rating system may be to avoid changing a consumer's typical habits regarding content consumption. In this way, the system is expected to run seamlessly in the background.

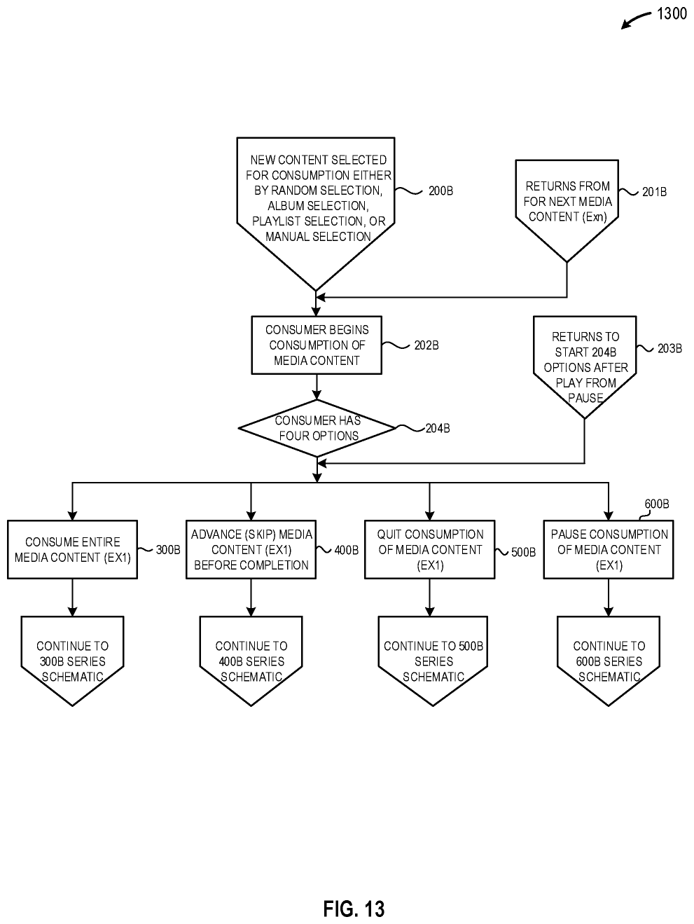

FIG. 13 illustrates a flowchart of example operations for identifying the options available to a consumer at an initial phase of calculating the approval rating of an example media content for a single consumer who chooses to let the system automatically select media content. Flowchart 1300 provides in greater detail example operations that may be executed after the consumer chooses to select content through random selection, album selection, content lists, or manual selection. The operations executed if content isn't selected is similar to that of the multiple consumer media rating system but without the restrictions and weights associated with having multiple consumers rate the same media content.

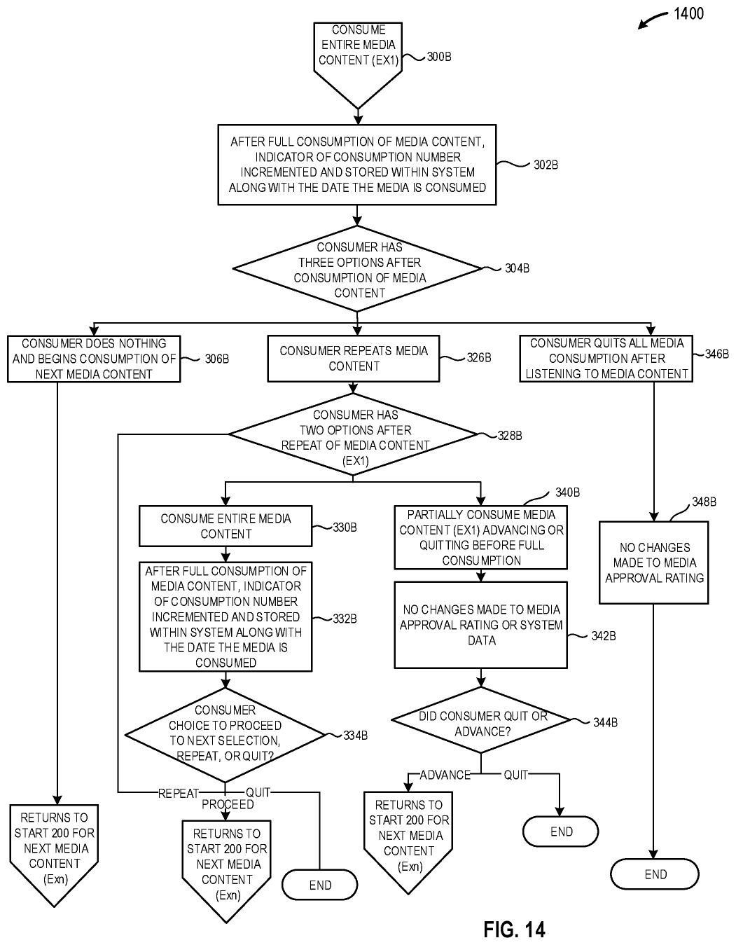

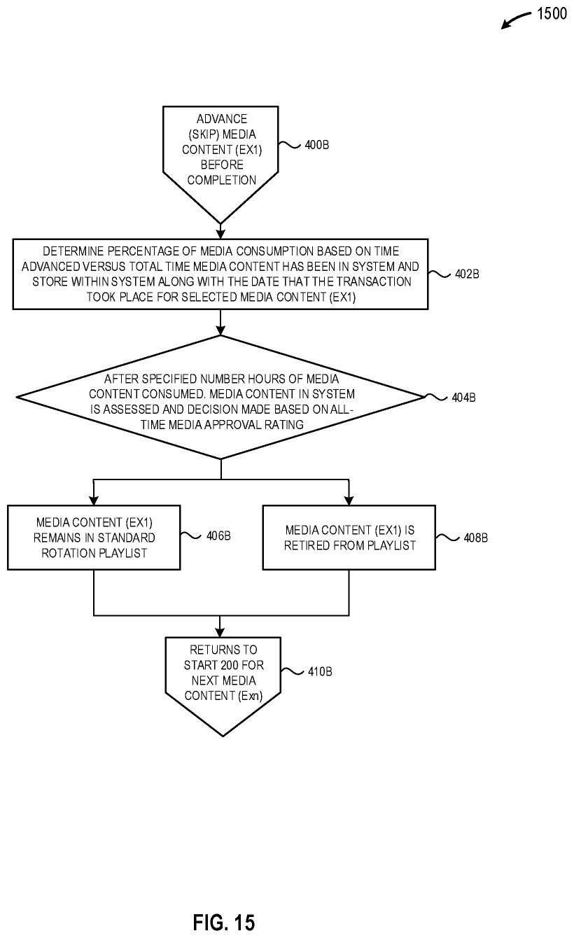

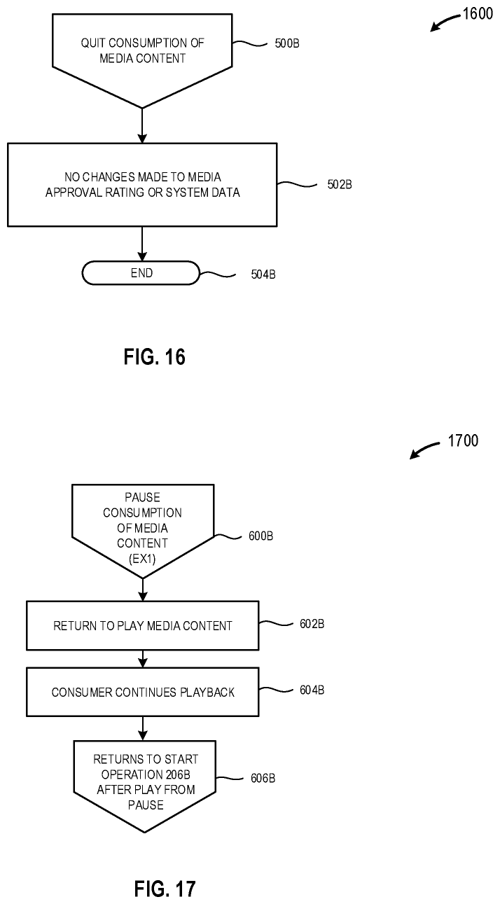

During consumption of the content in operation 202B, the consumer may be presented with options (e.g., four) as depicted in operation 204B. A first option may be to complete media consumption is shown at 300B. Example operations that may make up operation 300B are described in greater detail in FIG. 14. A second option wherein media content may be advanced before completion is shown in operation 400B. Process 400B explains the effect that advancing media content prior to consuming the content in its entirety may have on the media approval rating. Example operations that may make up operation 400B are described in greater detail in FIG. 15. A third options wherein a consumer quits the embodiment without fully consuming or advancing content is shown in operation 500B and focuses on actions that may be executed if the consumer quits the system during content consumption and without advancing the content. Example operations that may make up operation 500B are described in greater detail in FIG. 16.

In another option a consumer may pause consumption of media content a shown in operation 600B. Operation 600B may take into consideration a consumer who may need to pause media content during consumption. Example operations that may make up operation 600B are described in greater detail in FIG. 17.

FIG. 14 illustrates a flowchart of example operations that may be executed if a consumer chooses to consume in its entirety media content presented in an initial phase in a single consumer implementation. Flowchart 1400 in FIG. 14 may comprise operations that may occur when a consumer consumes the entire media content. A difference between the implementation of a media approval rating system for a single consumer compared to that of a multiple consumer system is that there is no need to assess the consumer historical behavior or bias. In fact, the media approval rating system for the single consumer may be completely biased. Therefore, after full consumption in operation 300B, a full media consumption entry with one hundred percent (100%) consumption is stored in operation 302B within the system to be assessed when determining the media approval rating for the presented content over the selected duration. In at least one embodiment, content may be deemed fully consumed (100% consumption rating) when at least seventy-five percent (75%) is actually consumed. Full consumption may be considered at seventy-five percent (75%) so that content ratings are not affected by white space, credits, or monologue that sometimes occurs at the end of media content. In at least one embodiment, the full consumption of the content may be stored along with the date the media is consumed.

After fully consuming the presented media content, the consumer may perform one of several actions per operation 304B. The consumer may do nothing and begin consumption of the next media content as shown in operation 306B, repeat the previously presented media content as shown in operation 326B or quit all media consumption as shown in operation 346B. Operation 306B may correspond to a consumer doing nothing and beginning consumption of the next piece of content. In this case, the system may return to FIG. 13, operation 201B to load the additional content. Proceeding to the next content may be considered the default behavior of the media approval rating system, and if the consumer chooses not to interact with the system the next content may be automatically loaded with consumption beginning soon after the previous media content is consumed in its entirety. A consumer's decision to repeat the selected media content may occur in operation 326B. After operation 326B the consumer may be presented with two options as shown in operations 330B and 340B. The consumer may choose to either consume the entire media again in operation 330B or may choose to advance or quit the media content prior to full consumption in operation 340B. Another difference between a single-consumer implementation of the media approval rating system as compared to that of a multiple-consumer system is the absence of the need to track how many times media content is repeated. Therefore, as indicated in operations 330B and 332B, all repeats may be treated as a full consumption of the content. Moreover, in this example implementation the media approval rating may be increased based on the number of times repeated by the consumer within a specified duration. After the information regarding the full consumption of the repeated material is logged in operation 332B, in operation 334B the consumer has the option to repeat the content again or return the system to FIG. 13, operation 201B for the next media content. The decision to repeat the content again may return the consumer to FIG. 14, Process 328B and as mentioned before the repeat may be considered to carry the same weight as a full consumption.

As shown in operation 340B, consumers who partially consume repeated media content by either advancing or quitting consumption before full consumption may not have any effect on the media approval rating of the selected content (e.g., operation 342B). A determination may then be made in operation 344B as to whether a consumer advanced the repeated content before the content was fully consumed (e.g., completed presentation of the content). If the content is determined to be advanced, the consumer may be returned by the system to FIG. 13, operation 201B to prepare for the selection and presentation of additional content. Consumers who quit before full consumption of the repeated content may then be exited from the system.

Another action available to consumers who consume the presented media content in its entirety would be to quit all media consumption as illustrated in operation 346B. As set forth in operation 348B, quitting the ratings system user interface application after full consumption of the content may not affect the media approval rating for previously consumed content or the next content to be presented, and the consumer may then be exited from the system. This is because quitting between media presentations may be considered an orderly exit from the system.

FIG. 15 illustrates a flowchart of example operations that may be executed if a consumer chooses to advance media content prior to completion presented in an initial phase in the single consumer implementation. Flowchart 1500 details logic that may execute if a consumer decides to advance (e.g., skip) selected content before full consumption. After a consumer advances the content prior to full consumption in operation 400B, in operation 402B a percentage of media consumption based on time of advance vs. a total time content has been available for selection in system is assessed and stored in the system to calculate the approval rating for media content over a specified duration. In operation 404B, media content that exists within the system with an all-time approval rating less than a certain percentage (e.g., 50%) after a certain amount of content consumption (e.g., at least one-hundred hours of total media is consumed) may then be put to additional tests. These additional tests may comprise, for example, determining how often the content is manually selected by the user, how often the user skips the content when the content is automatically selected for presentation, etc. Based on this all-time approval rating, a decision may then be made to select operations 406B or select operation 408B. Operation 406B may be selected if it is determined if the all-time approval rating is above a certain percentage (e.g., 50%) and the minimum number of hours of total media consumption is met. The content may remain on a standard rotation content list. Different outcomes may be generated by either the rating or minimum number of hours requirements not being met. For example, if the minimum number of hours requirement is not net, the content may be added to a specialized content list to increase the frequency of selection (e.g., to increase content playback and ratings generation for the content). If the overall approval rating for the content is negative and the hours requirement has been met, the content may be deemed as unpopular. The content may then be removed from the standard or specialized content lists, or from the content library. Content removal may allow the system to maintain memory consumption at reasonable levels, add new content, etc. The consumer may then be returned to FIG. 13, operation 201B, to prepare for additional content selection.

FIG. 16 illustrates a flowchart of example operations that may be executed if a consumer chooses to quit the media approval rating system without fully consuming media content in a single consumer implementation. Flowchart 1600 in FIG. 16 depicts how a consumer may quit the system prior to full consumption. If the consumer quits the system prior to full consumption and without advancing the content in operation 500B, then no changes are made to the media consumption rating for the selected media content in operation 502B. The consumption rating may not be affected by a consumer quitting the system because the reason for the quit may be unrelated to user intention such as system timeout, power loss, etc. The actions executed after the consumer quits the system may be another difference between the media approval rating system with a single consumer compared to that of the media approval rating system with multiple consumers. Due to the system being designed to gather the approval ratings of a single consumer, there may be no any penalty for quitting the system at any time. The consumer may then exit the system in operation 504B.

FIG. 17 illustrates a flowchart of example operations that may be executed if a consumer chooses to pause media content during consumption in a single consumer implementation. Flowchart 1700 discloses an example of how the system may handle a consumer pausing consumption of content. Consumers may pause content consumption in operation 600B. As opposed to a multiple consumer system, paused media is simply paused in the single consumer system. There are not any timeouts because the system does not depend on the ratings of multiple consumers. Therefore, in the case of the single consumer media approval rating system, the media content can be paused by the consumer as shown in operation 602B and resumed by the consumer as shown in operation 604B. In operation 606B playback resumes, which may be followed by FIG. 13, operation 203B to continue with the consumption of the selected content.

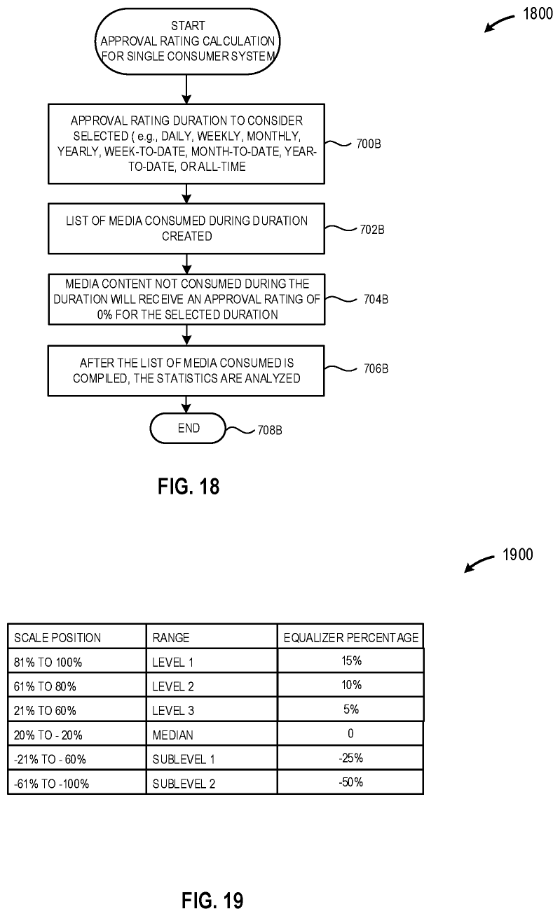

FIG. 18 illustrates a flowchart comprising example operations for defining the approval rating calculation for a single consumer implementation. Following the gathering of statistics of presented content, calculation of approval ratings for the imported media over the specified duration may commence. After a duration is selected from the available options (e.g., daily, weekly, monthly, yearly, week-to-date, month-to-date, year-to-date, or all-time) in operation 700B, the system may first compose a list of all content consumed during the selected duration as indicated in operation 702B. Content that was not consumed during the selected approval rating duration may receive an approval rating of zero percent (0%) for the selected duration in operation 704B. All consumed content would then be analyzed in operation 706B. The first stage of analysis may comprise calculating an approval rating for the media based on the total length of the media presented to the consumer, and to then total duration of the media consumed. For example, first content is a song or video from a consumer's media library that is five minutes in length. If the first content is presented to the consumer six times during a selected duration of time, then the total length of the content presented, which in this case would be the first content, would be thirty minutes. If each time the first content was presented, the consumer only actually consumed three minutes of the content during the duration, the total media consumed during the duration selected would be eighteen minutes. Thus, the calculated approval rating for the first content would be eighteen minutes divided by thirty minutes. The calculated approval rating would then be 0.6 or 60%.

In at least one embodiment, after the calculated approval rating is computed for all media content presented within the selected duration, equalizer bonus percentages may then be assessed and applied to the calculated approval rating. Equalizer bonus points may be utilized to provide balancing to content ratings by taking into consideration the number of times the content was presented to a consumer along with the total duration of the content consumed. For example, second content presented to the consumer once and receiving an overall approval rating of 100% should not be deemed to have better consumer acceptance than third media content presented to the consumer on ten separate occasions and received an overall approval rating of 90%. Equalizer bonus percentages may be determined by first gathering the ratio of the number of times the media content was presented vs. the total number of presentations of media content. This ratio may hereafter be referred to as a presentation ratio. For example, selected duration content was presented to the consumer a total of seventeen times. If the third content was presented five of the seventeen total times, then Media Content C would have a presentation ratio of 5:17 or 29.41%.

After calculating presentation ratios for all presented content, a content list is generated in operation 706B. The content may be ordered from the highest presentation ratio to the lowest presentation ratio. At this point, the list may be broken up into different equalizer levels defined, for example, in chart 1900 of FIG. 9. Determining a differentiator between levels may begin with determining a median presentation ratio from the content list. After the median presentation ratio is determined, scales may be generated. One scale may be from the median presentation value to the maximum presentation value within the list. Another scale may be from the median presentation value to the minimum presentation value from the list. Splitting the content into at least two scales allows the system to construct an equalizer scale from 100% to −100%.

Prior to explaining how equalizer percentages may be assigned to media content approval ratings, it is important to understand how the scales are determined. The upper scale (e.g., from 0% to 100%) may be constructed by determining a maximum presentation ratio and determining the range from the maximum presentation ratio to a median presentation ratio. After the range is determined the upper scale may be split into ranges such as, for example, Level 1, Level 2, Level 3, and Median. In at least one implementation, the median range may span from 0 to 20%; the Level 3 range may span from 21% to 60%; the Level 2 range may span from 61% to 80% and the Level 1 range may span from 81% to 100%. After the upper scale is determined, a lower scale (e.g., from 0% to −100%) may be determined utilizing the same method to determine the range from the median presentation ratio to the minimum presentation ratio. After the range is determined, the lower scale may be split into ranges such as, for example, Sublevel 2, Sublevel 1, and Median. In at least one implementation, the Median range may span from 0% to −20%; the Sublevel 1 range may span from −21% to −60% and the Sublevel 2 range may span from −61% to −100%.

Following determination of the ranges, content may be assessed to determine its position within the range. For example, a first determination may be made as to whether the content has a selected media content presentation ratio above, below, or equal to the median presentation ratio. If it is determined that the selected content has a selected media content presentation ratio above the median presentation ratio, the scale position may be calculated using the following equation:

(Selected Media Content Presentation Ratio−Median Presentation Ratio)/(Upper Range). (Eq. 7)

Otherwise, if the selected media content presentation ratio is determined to be below the median presentation ratio, the scale position may be calculated using the following equation:

(Median Presentation Ratio−Selected Media Content Presentation Ratio)/(Lower Range). (Eq. 8)

In at least one embodiment, content determined to be within the Level 1 range may be assigned a positive equalizer percentage of 15%; content determined to be within the Level 2 range may be assigned a positive equalizer percentage of 10% and content determined to be within the Level 3 range may be assigned a positive equalizer percentage of 5%. Positive equalizer percentages may be awarded to content based on how often the content is played during a selected duration of time. Assigning equalizer percentages to content acknowledges that content selected for presentation, either manually or via automatic selection, should receive a boost. Content determined to be within the Median range may not be assigned any equalizer percentage. Content determined to be within the Sublevel 1 range may be assigned a negative equalizer percentage of −25% and content determined to be within the Sublevel 2 range may be assigned a negative equalizer percentage of −50%. The negative equalizer percentages may help to ensure that content with the fewer consumptions are not assigned higher approval percentages than content that is more frequently presented to the consumer. The single consumer media approval rating system may provide approval ratings corresponding to the specified ranges, and in doing so the approval rating for the highest range should include the content with the highest consumption and approval rating during that period. The rating may be adjusted based on the popularity of the content (e.g., how often the content is consumed), which overall is the purpose of the equalizer percentage. After the equalizer percentage is calculated, it is then added to or subtracted from consumption percentage to gather the overall approval rating percentage for the content. The consumer may then exit the system in operation 708B.

Techniques and methodologies embodying the principles described may be implemented in any suitable manner including hardware, software and combinations thereof. Included in the disclosure are methods of implementing a system to provide an overall approval rating of media content based on consumer interaction with the presented content. The disclosed processing and decision blocks may represent operations and/or actions that may be included in any system to carry out these various operations to provide an overall approval rating. Systems derived from these processes may be implemented as software implemented with and directing the operation of one or more multi-purpose processors. It should be appreciated that the flowcharts included do not depict the syntax or operation of a specific system, of any specific programming language or type of programming language. Rather, the flow charts illustrate the definition of any system used to fabricate systems or algorithms to perform the generation of the approval rating of media content based on the consumption of the media by the consumer. It should also be appreciated that, unless otherwise indicated, the described sequence of processes and decisions described in each flow chart is merely illustrative of the system that may be implemented and can be varied in implementation and embodiments of the principles described. Accordingly, in some embodiments the techniques described herein may be embodied in computer-executable instructions implemented as software, including as application software, system software, firmware, middleware or other suitable type of software. Such computer-executable instructions may be composed employing a variety of suitable programming languages and/or programming or scripting tools, and may be compiled as executable machine language code or intermediate code that is executed on a framework, virtual machine, etc.

Computer-executable instructions to execute the various techniques or methodologies disclosed herein may be implemented in any suitable manner, including as resources providing one or more operations needed to complete execution of relevant algorithms. These resources, however instantiated, may be structural components of a computer system that, when integrated with and executed by one or more computers, causes the one or more computers to perform a specific operational role. A resource may be a portion of or an entire software element. For example, a resource may be implemented as a function of a process, or as a discrete process, or as any other suitable unit of processing. If the techniques or methodologies described herein are implemented as multiple resources, each resource may be implemented separately and uniquely. In addition, these resources may be executed in parallel or serially, as appropriate, and may pass information between one another using a shared memory on the computer device or devices on which they are executing, using a message passing protocol, or in any other suitable way. Generally, resources may include routines, programs, objects, components, data structures, etc. that may perform certain tasks or implement abstract data types. Typically, the functionality of the resources may be combined or distributed as desired in the systems in which they operate. In some implementation, one or more functional facilities carrying out techniques herein may together form a complete software package. Some exemplary resources have been described herein for carrying out one or more tasks. It should be appreciated, though, that the functional facilities and division of tasks described is merely illustrative of the type of resources that may implement the exemplary techniques described herein, and that embodiments are not limited to being implemented in any specific number, division, or type of functional facilities. In some implementations, all functionality may be implemented in a single resource. It should also be appreciated that, in some implementations, some of the resources described herein may be implemented together with or separate from others (i.e., as a single unit or separate units), or some of these functional facilities may not be implemented.

Computer-executable instructions implementing the techniques described (when implemented as one or more functional facilities or in any other manner) may, in some embodiments, be encoded on one or more computer readable media to provide functionality to the media. Computer-readable media may comprise magnetic media such as a hard disk drive, optical media such as a Compact Disk (CD) or a solid-state memory (e.g., Flash memory, Magnetic RAM, etc.), or any other suitable storage media. Such as a computer readable medium may be implemented in any suitable manner, including as computer-readable storage media or as a stand-alone, separate storage medium. As used herein, “computer-readable media” (also called “computer-readable storage media”) may refer to non-transitory storage media including at least one physical, structural component. In a “computer readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer readable medium may be altered during a recording process. Further, some techniques described above comprise acts of storing information (e.g., data and/or instructions) in certain ways for use by these techniques. In some implementations of these techniques-such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantages structures may then provide functionality to the storage medium by affecting operations of one or more processors interacting with information; for example, by increasing the efficiency of computer operations performed by the processor(s).

In at least one embodiment, computer-readable instructions to perform the techniques and methodologies described herein may be executed by one or more computing device(s) operating in a system. The computer-readable instructions may control the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to the executing the various techniques and methodologies described herein, one or more Field-Programmable Gate Arrays (FPGAs) for carrying out the techniques described herein, or any other suitable system.

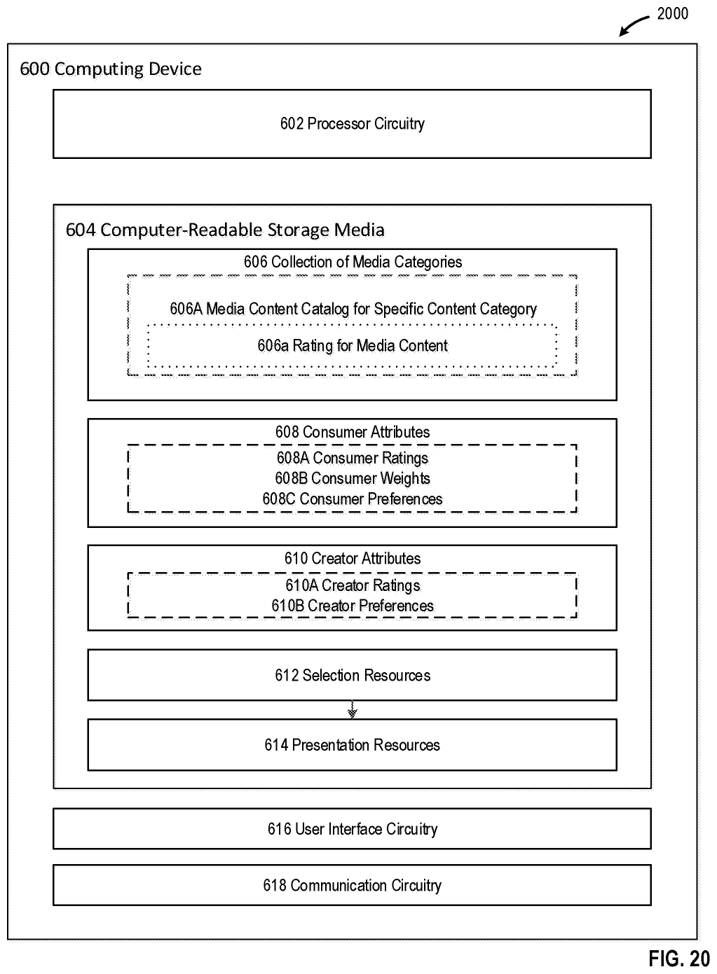

FIG. 20 illustrates a block diagram of an example computing device with which various embodiments may operate. System layout 2000 of FIG. 20 illustrates an example implementation of functional components that may be used to implement the techniques described herein. FIG. 20 does not depict components that would be required or necessary for computer device 600 to operate in accordance with the principles described herein. The purpose of FIG. 20 is to merely to demonstrate how computer device 600 may be configured to support the various operations disclosed herein.

System Device 600 may comprise processor circuitry 602, at least one computer-readable storage media 604, user interface circuitry 616 and communication circuitry 618. Examples of system device 600 may include, but are not limited to, a typically stationary computing device such as a desktop computer, a server computer, a “smart” television, a set-top box to control a “dumb” television, etc., or a typically portable computing device such as a laptop computer, a netbook computer, a tablet computer, a mobile communication device like a cellular handset, a wearable computing device, the above devices in combination or a dedicated device that may be used to output media content (e.g., a media player or streaming device). Processor circuitry 602 may comprise one or more processors in the form of an integrated processor comprising multiple processing cores that are generally configured or with a specific purpose, and/or separate general and/or dedicated data processors. Processor circuitry 602 may further comprise support circuitry including componentry, chips, chipsets or multichip modules (MCM) configured to support the operation of the data processors. Support circuitry may include, for example, communication circuitry, interface circuitry, bus control circuitry, security circuitry, power circuitry, etc.

System-readable media 604 may comprise volatile or non-volatile memory circuitry adapted to store data to be processed and/or instructions to be executed by processor(s) 602. Volatile memory may comprise at least random access memory (RAM). Non-volatile memory may comprise at least read-only memory (ROM), hard drives based on electromagnetic, solid state or other technologies, electronically programmable read only memories (EPROM), Flash and other similar memories/technologies. The data and instructions stored on system-readable media 604 may comprise of executable instructions and data utilized to implement techniques described herein. System-readable media 604 may comprise collection of Media Categories 606, consumer attributes 608, creator attributes 610, selection resources 612, and presentation resources 614. As previously mentioned, the system depicted in FIG. 20 only provides various examples of functional components that may be employed to implement the techniques and methodologies described herein. Computing device 600 is not limited to the components defined in FIG. 20 and may use peripheral devices available to the system to implement the techniques defined herein.

Collection of media categories 606 may be stored on computer-readable storage media 604 and may serve the functional purpose of storing a collection of media categories for content (e.g., audio and video media) to be used within the techniques described herein. Collection of media categories 606 may also include subcomponent 606A that corresponds to a media content catalog for each specific media category available within the system. Each individual media content may include an overall approval rating and statistics as defined in rating for media content 606A, which may be updated using the various techniques and methodologies disclosed herein. The content may be selected and developed to include suitable content in a variety of formats. Consumer attributes 608 may serve the functional purpose of storing consumer attributes such as, for example, user identification information, subscription level, payment information, content preference information, content lists, control preference information, etc. Consumer attributes 608 may exist in one or more systems and together with the consumer actions may be used to calculate the overall approval rating. In at least one embodiment, consumer attributes 608 may include consumer ratings 608A, consumer weights 608B and consumer preferences 608C. Subcomponents 608A-608C may be used to store consumer actions, status, ratings, and any other parameters that may be utilized by the consumption rating system for each consumer.

Creator Attributes 610 may serve the functional purpose of storing creator attributes that may be used for the techniques and methodologies described herein. In addition, creator attributes 610 may be used to save statistic information for each creator. Creator attributes 610 may exist on one or more systems. In at least one embodiment, creator attributes 610 may include, but are not limited to, creator ratings 610A and creator preferences 610B. Subcomponents 610A and 610 B may be used to contain information on creator ratings and system preferences.

Selection resources 612 may exist on a single or multiple systems and may serve the functional purpose of selecting the media content to be presented to the consumer. Selection may be based on, but not limited to, consumer preference and content rating. Presentation Facility 614 may exist on a single or multiple systems and may utilize any peripheral available. At least one functional purpose of the presentation facility may be to provide the consumer and creator a means of interacting with the media consumption system. Interaction may include, but is not limited to, the presentation of selected media content to the consumer; methods for logging into the system; and the presentation of statistics to all consumers.

In at least one embodiment, presentation resources 610 may interact with user interface circuitry 616 and/or communication circuitry 618. User interface circuitry 616 may include hardware and/or software to allow consumers to interact with computing device 600 such as, for example, various input mechanisms (e.g., microphones, switches, buttons, knobs, keyboards, speakers, touch-sensitive surfaces, one or more sensors configured to capture images, video and/or sense proximity, distance, motion, gestures, orientation, biometric data, etc.) and various output mechanisms (e.g., speakers, displays, lighted/flashing indicators, electromechanical components for vibration, motion, etc.). Hardware in user interface circuitry 616 may be included in computing device 600 and/or may be coupled to computing device 600 via a wired or wireless communication medium. Communication interface circuitry 618 may be configured to manage packet routing and other control functions for wired and/or wireless communications. In some instances, computing device 600 may comprise more than one set of communication circuitry 618 (e.g., including separate physical interface circuitry for wired protocols and/or wireless radios). Wired communications may include serial and parallel wired mediums such as, for example, Ethernet, USB, FireWire®, Thunderbolt™, Digital Video Interface (DVI), High-Definition Multimedia Interface (HDMI), DisplayPort™, etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth®, WLAN, Wi-Fi, etc.), long range wireless mediums (e.g., cellular wide-area radio communication technology, satellite-based communications, etc.), electronic communications via sound waves, long-range optical communications, etc. In one embodiment, communication circuitry 618 may be configured to prevent wireless communications that are active from interfering with each other. In performing this function, communication circuitry 618 may schedule communication activities based on, for example, the relative priority of messages awaiting transmission.

In an example of operation, computing device may receive content for presentation to a consumer via communication circuitry 618, and may provide ratings information to portions of consumer attributes 608 and/or creator attributes 610 via communication circuitry 618. When a consumer interacts with computing device 600, presentation resources 614 may formulate a user interface including control features (e.g., soft buttons, touch areas, etc.), or at least consolidate consumer, creator and/or content-related information for use in populating a user interface, for presentation to the consumer. Presentation resources 614 may then cause user interface circuitry 616 to present (e.g., display) a user interface to the consumer. The consumer may then interact with the control features that are displayed in the user interface to advance content, pause content presentation, repeat content presentation, exit the content rating system, etc. In at least one embodiment, the user interface presented to the user may comprise functionality to improve operation of the computing device 600. For example, a consumer manipulating controls presented in the user interface may cause content to be paused, skipped, etc. As disclosed above, these actions may cause the rating for the consumer and/or content currently being consumed to change. In at least one example implementation, presentation of the user interface may change to provide a foreground or background indicator to the consumer that the rating for the consumer or content has changed, and may further indicate how the rating has been changed. For example, selecting to skip content prior to full consumption (e.g., playback) of the content may cause the rating for the content to drop. This may be indicated in the background of the user interface via visible indicia such as a color change or displayed object, through a noise generated by the user interface, through tactile feedback (e.g., a vibration or pattern of vibration), etc. Consuming content in entirety may cause the rating for the content to rise, and may instead elicit a positive indicator in the user interface. Skipping content regularly may cause a consumer's rating to drop, which may also be indicated in the user interface. The user interface may also be configured to advise a user about their current status (e.g., executive, premium or standard) and/if that status is in danger of being reduced. The user interface may also advise when the system has determined to remove content from a consumer's content list or the system in general, and the effect of removing the content on the memory consumption in computing device 600.

In certain embodiments, a media approval rating system in accordance with the techniques presented herein may be utilized as a differentiator of media content with respect to one or more aspects of providing the media content. For example, media content may be associated with one or more differentiated tiers of network bandwidth, delivery priority, delivery costs, consumption costs, or other aspects, with such differentiated tiers being based at least in part on one or more relative consumer ratings of such media content. In one embodiment, for example, a network service provider may determine to associate a higher network delivery priority, and/or a cost for providing particular media content, as a result of an aggregated consumer rating for such media content being higher than other content that the network service provider assigns a lower network delivery priority and/or cost.

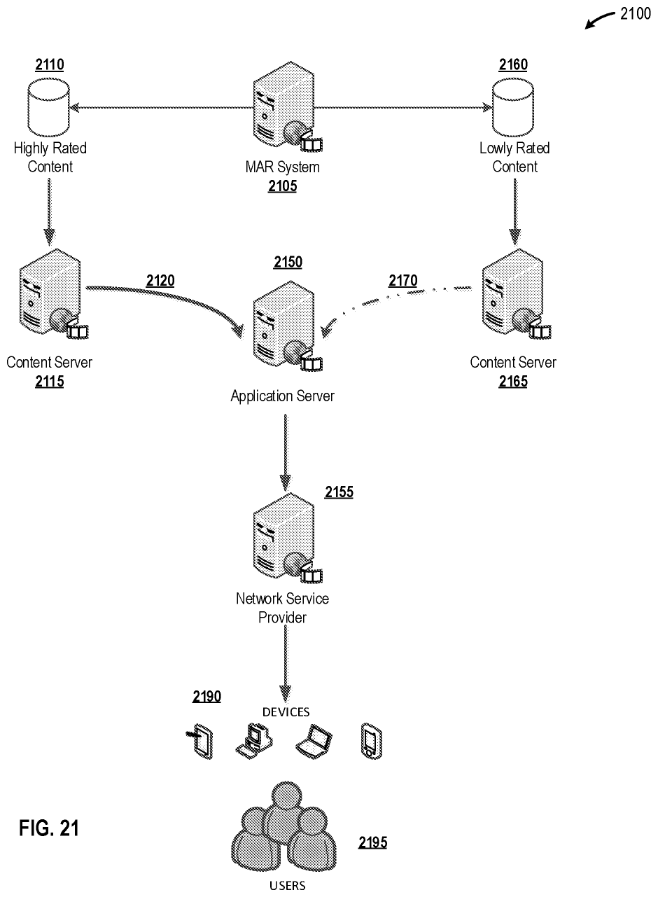

FIG. 21 illustrates an overview of an exemplary system 2100 that includes an embodiment of a media approval rating (MAR) system 2105. In the depicted embodiment, the MAR system 2105 may utilize multiple computing devices configured to communicate over one or more computer networks in order to differentiate delivery between media content associated with relatively high ratings from other media content associated with relatively low ratings. In the depicted embodiment, the MAR system 2105 causes a first content server 2115 to be provisioned with relatively high-rated media content in a first media database 2110, and causes a second content server 2165 to be provisioned with relatively low-rated media content from a second media database 2160. It will be appreciated that in certain alternative embodiments, various alternative server arrangements may be utilized without deviating from the intent and scope of the techniques described herein. For example, the MAR system 2105 may incorporate one or both of content servers 2115 and 2165; alternatively, a single content server (not shown) may provide differentiated access to media content determined by the MAR system 2105 to be associated with highly rated or lowly rated content, respectively.

In the depicted embodiment, content server 2115 is communicatively coupled to an application server 2150 via a high-priority, high-bandwidth connection 2120. In contrast, content server 2165 is communicatively coupled to the application server 2150 via a low-priority, low-bandwidth connection 2170. Thus, highly rated media content stored in the first media database 2110 is provided to the application server via the high-priority, high-bandwidth connection, whereas lowly rated media content stored in the second media database 2160 is provided to the application server 2150 via the low-priority, low-bandwidth connection. The application server 2150 is further communicatively coupled to a network service provider 2155, to which it may provide any media content requested by users 2195 via one or more of associated devices 2190, such as via one or more wired and/or wireless computing networks. In addition, the transmission of such differentiated content may be further differentiated via one or more monetary fees or other charges, such as by associating the highly rated content of first content server 2115 with higher fees, transmission charges, or other fee schedules that are (as a non-limiting example) higher than those associated with the lowly rated content of second content server 2165.

In certain embodiments, the MAR system may choose to designate new content and/or content in high demand as highly rated media content for purposes of such differentiated treatment, thereby causing such content to be provisioned to the first content server 2115 despite (as one example) such content not yet having been associated with a particular rating that would otherwise warrant such provisioning. After such media content has been available for a duration sufficient to receive a rating, the MAR system may determine to move the media content to the second content server 2165, such as if the associated rating is below a defined threshold.

Moreover, in at least some embodiments, ratings and differentiated treatment of associated media content may be localized, such as based on one or more geographic locations in which disparate ratings and/or disparate rates of media content consumption are associated with specific media content. For instance, if particular content (and/or categories of such content) is consumed more in the country A than in the Country B, the MAR system may utilize localized ratings and/or consumption rates to determine which media content is to be respectively provisioned on content servers associated with high-priority, high-bandwidth connections or low-priority, low-bandwidth connections.

While FIGS. 3-7 and 12-18 illustrate operations according to different embodiments, it is to be understood that not all of the operations depicted in FIGS. 3-7 and 12-18 are necessary for other embodiments. Indeed, it is fully contemplated herein that in other embodiments of the present disclosure, the operations depicted in FIGS. 3-7 and 12-18, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for managing content using implicit weighted ratings.

According to example 1 there is provided at least one device to manage content. The at least one device may comprise user interface circuitry to present at least a user interface, processor circuitry to execute instructions causing the processor circuitry to determine a rating for a consumer of content, cause the user interface circuitry to present a user interface to the consumer to allow the consumer to consume the content, monitor operations for controlling the content presentation received via the user interface circuitry, determine changes to a rating for the content based at least on the consumer rating and the monitored operations, update the rating of the content based on the determined changes and control device operation based on the updated content rating.

Example 2 may include the elements of example 1, wherein the at least one device comprises at least one ratings system device and at least one user device including communication circuitry to at least one of download the content from the at least one ratings system device to the at least one user device or upload information for determining at least one of a consumer rating or a content rating from the at least one user device to the at least one ratings system device.

Example 3 may include the elements of any of examples 1 to 2, wherein the processing circuitry is to determine the consumer rating based on at least one of the monitored operations or a consumer profile including at least consumer content category preferences and a consumer status.

Example 4 may include the elements of any of examples 1 to 3, wherein the user interface is to present at least one control feature to allow the consumer to execute at least the operations of advancing the content presentation, pausing the content presentation and exiting the content presentation.

Example 5 may include the elements of example 4, wherein allowing the content to be fully presented causes the processing circuitry to increase the content rating and advancing the content presentation prior to the full presentation of the content causes the processing circuitry to reduce the content rating.

Example 6 may include the elements of example 5, wherein the consumer requesting to repeat fully presented content causes the processing circuitry to increase the content rating, and each subsequent request from the consumer to repeat reduces the amount of increase to the content rating.

Example 7 may include the elements of any of examples 4 to 6, wherein pausing the content longer than a predetermined time period for more than a predetermined number of times causes the processing circuitry to reduce the consumer rating.

Example 8 may include the elements of any of examples 1 to 7, wherein the processing circuitry controlling the at least one device comprises causing the processing circuitry to at least one of remove the content from the at least one device or alter the appearance of the user interface based on changes in the consumer rating or content rating.

According to example 9 there is provided a method for content management. The method may comprise determining a rating for a consumer of content, causing user interface circuitry in at least one device to present a user interface to the consumer to allow the consumer to consume the content, monitoring operations for controlling the content presentation received via the user interface circuitry, determining changes to a rating for the content based at least on the consumer rating and the monitored operations, updating the rating of the content based on the determined changes and controlling device operation based on the updated content rating.

Example 10 may include the elements of example 9, wherein the consumer rating is determined based on at least one of the monitored operations or a consumer profile including at least consumer content category preferences and a consumer status.

Example 11 may include the elements of any of examples 9 to 10, wherein the user interface presents at least one control feature to allow the consumer to execute at least the operations of advancing the content presentation, pausing the content presentation and exiting the content presentation.

Example 12 may include the elements of example 11, wherein allowing the content to be fully presented increases the content rating and advancing the content presentation prior to the full presentation of the content reduces the content rating.

Example 13 may include the elements of example 12, wherein the consumer requesting to repeat fully presented content increases the content rating, and each subsequent request from the consumer to repeat reduces the amount of increase to the content rating.

Example 14 may include the elements of any of examples 9 to 13, wherein controlling the at least one device comprises at least one of removing the content from the at least one device or altering the appearance of the user interface based on changes in the consumer rating or content rating.

According to example 15 there is provided at least one machine-readable storage medium having stored thereon, individually or in combination, instructions for content management. The instructions for content management, when executed by one or more processors, may cause the one or more processors to determine a rating for a consumer of content, cause user interface circuitry in at least one device to present a user interface to the consumer to allow the consumer to consume the content, monitor operations for controlling the content presentation received via the user interface circuitry, determine changes to a rating for the content based at least on the consumer rating and the monitored operations, update the rating of the content based on the determined changes and control device operation based on the updated content rating.

Example 16 may include the elements of example of claim 15, wherein the consumer rating is determined based on at least one of the monitored operations or a consumer profile including at least consumer content category preferences and a consumer status.

Example 17 may include the elements of any of examples 15 to 16, wherein the user interface presents at least one control feature to allow the consumer to execute at least the operations of advancing the content presentation, pausing the content presentation and exiting the content presentation.

Example 18 may include the elements of example 17, wherein allowing the content to be fully presented executes instructions to increase the content rating and advancing the content presentation prior to the full presentation of the content executes instructions to reduce the content rating.

Example 19 may include the elements of example 18, wherein the consumer requesting to repeat fully presented content executes instructions to increase the content rating, and each subsequent request from the consumer to repeat reduces the amount of increase to the content rating

Example 20 may include the elements of any of examples 15 to 19, wherein the instructions to control the at least one device comprise instructions to at least one of remove the content from the at least one device or alter the appearance of the user interface based on changes in the consumer rating or content rating.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. At least one device to manage content, comprising:
user interface circuitry to present at least a user interface;
processor circuitry to execute instructions causing the processor circuitry to:
determine a rating for a consumer of content;
cause the user interface circuitry to present a user interface to the consumer to allow the consumer to consume the content;
monitor operations for controlling the content presentation received via the user interface circuitry;
determine changes to a rating for the content based at least on the consumer rating and the monitored operations;
update the rating of the content based on the determined changes; and
control device operation based on the updated content rating.

2. The at least one device of claim 1, wherein the at least one device comprises at least one ratings system device and at least one user device including communication circuitry to at least one of download the content from the at least one ratings system device to the at least one user device or upload information for determining at least one of a consumer rating or a content rating from the at least one user device to the at least one ratings system device.

3. The at least one device of claim 1, wherein the processing circuitry is to determine the consumer rating based on at least one of the monitored operations or a consumer profile including at least consumer content category preferences and a consumer status.

4. The at least one device of claim 1, wherein the user interface is to present at least one control feature to allow the consumer to execute at least the operations of advancing the content presentation, pausing the content presentation and exiting the content presentation.

5. The at least one device of claim 4, wherein allowing the content to be fully presented causes the processing circuitry to increase the content rating and advancing the content presentation prior to the full presentation of the content causes the processing circuitry to reduce the content rating.

6. The at least one device of claim 5, wherein the consumer requesting to repeat fully presented content causes the processing circuitry to increase the content rating, and each subsequent request from the consumer to repeat reduces the amount of increase to the content rating.

7. The at least one device of claim 4, wherein pausing the content longer than a predetermined time period for more than a predetermined number of times causes the processing circuitry to reduce the consumer rating.

8. The at least one device of claim 1, wherein the processing circuitry controlling the at least one device comprises causing the processing circuitry to at least one of remove the content from the at least one device or alter the appearance of the user interface based on changes in the consumer rating or content rating.

9. A method for content management, comprising:
determining a rating for a consumer of content;
causing user interface circuitry in at least one device to present a user interface to the consumer to allow the consumer to consume the content;
monitoring operations for controlling the content presentation received via the user interface circuitry;
determining changes to a rating for the content based at least on the consumer rating and the monitored operations;
updating the rating of the content based on the determined changes; and
controlling device operation based on the updated content rating.

10. The method of claim 9, wherein the consumer rating is determined based on at least one of the monitored operations or a consumer profile including at least consumer content category preferences and a consumer status.

11. The method of claim 9, wherein the user interface presents at least one control feature to allow the consumer to execute at least the operations of advancing the content presentation, pausing the content presentation and exiting the content presentation.

12. The method of claim 11, wherein allowing the content to be fully presented increases the content rating and advancing the content presentation prior to the full presentation of the content reduces the content rating.

13. The method of claim 12, wherein the consumer requesting to repeat fully presented content increases the content rating, and each subsequent request from the consumer to repeat reduces the amount of increase to the content rating.

14. The method of claim 9, wherein controlling the at least one device comprises at least one of removing the content from the at least one device or altering the appearance of the user interface based on changes in the consumer rating or content rating.

15. At least one machine-readable storage medium having stored thereon, individually or in combination, instructions for content management that, when executed by one or more processors, cause the one or more processors to:
determine a rating for a consumer of content;
cause user interface circuitry in at least one device to present a user interface to the consumer to allow the consumer to consume the content;
monitor operations for controlling the content presentation received via the user interface circuitry;
determine changes to a rating for the content based at least on the consumer rating and the monitored operations;
update the rating of the content based on the determined changes; and
control device operation based on the updated content rating.

16. The storage medium of claim 15, wherein the consumer rating is determined based on at least one of the monitored operations or a consumer profile including at least consumer content category preferences and a consumer status.

17. The storage medium of claim 15, wherein the user interface presents at least one control feature to allow the consumer to execute at least the operations of advancing the content presentation, pausing the content presentation and exiting the content presentation.

18. The storage medium of claim 17, wherein allowing the content to be fully presented executes instructions to increase the content rating and advancing the content presentation prior to the full presentation of the content executes instructions to reduce the content rating.

19. The storage medium of claim 18, wherein the consumer requesting to repeat fully presented content executes instructions to increase the content rating, and each subsequent request from the consumer to repeat reduces the amount of increase to the content rating

20. The storage medium of claim 15, wherein the instructions to control the at least one device comprise instructions to at least one of remove the content from the at least one device or alter the appearance of the user interface based on changes in the consumer rating or content rating.
